(19) United States
(12) Patent Application Publication
(10) Pub. No.: US 2017/0259894 A1
(43) Pub. Date: Sep. 14, 2017

(54) BUOYANCY VEST VENT VALVE WITH RELIABLE SEATING

(71) Applicant: AI Control Technologies, Inc., Boca Raton, FL (US)

(72) Inventors: Andrew Sinclair, Southwater (GB); Christopher Webb, Les Collons (CH)

(21) Appl. No.: 15/607,609

(22) Filed: May 29, 2017

Related U.S. Application Data
(63) Continuation-in-part of application No. 15/048,953, filed on Feb. 19, 2016, now Pat. No. 9,663,203.
Application No. 15/048,953 is a continuation-in-part of application No. 14/059,496, filed on Oct. 22, 2013, now abandoned.
Application No. 14/059,496 is a continuation-in-part of application No. 13/432,063, filed on Mar. 28, 2012, now abandoned.

(51) Int. Cl. B63C 9/08; F16K 31/56; B63C 11/08; B60C 29/00

(52) U.S. Cl. CPC B63C 9/081; B63C 9/24; F16K 31/566; B63C 11/08; B63C 11/02

(57) ABSTRACT

A vent valve for a buoyancy control device (“BCD”) suitable for divers, where the valve may be opened by any combination of over-pressure, manual pressure relief or a powered means, where a force to a valve plug is applied by means of a spring that is constrained to prevent entirely lateral and angular movement but in which movement of the plug in the axis of the seat is unconstrained. An automatic buoyancy control device suitable for free-swimming divers, providing the functions that may include a controlled ascent rate, controlled descent rates, the imposition of a maximum depth limit, the facility to hold a set depth and to follow a dive profile or decompression profile. The device, control process and subsystems provide a high safe failure fraction.

### CROSS-REFERENCE TO RELATED APPLICATIONS

This application is a continuation-in-part of U.S. patent application Ser. No. 15/048,953, filed on Feb. 19, 2016, which is a continuation-in-part of U.S. patent application Ser. No. 14/059,496, filed on Oct. 22, 2013, and is now abandoned, which application is also a continuation-in-part of U.S. patent application Ser. No. 13/432,063, filed on Mar. 28, 2012, and is now abandoned, the disclosures of which are incorporated herein by reference.

### TECHNICAL FIELD

This description relates generally to the control of diver buoyancy and buoyancy compensation.

### BACKGROUND

Buoyancy Vest Vent Valve with Reliable Seating

Divers commonly use a Buoyancy Compensation Device (“BCD”) to compensate for the changes in buoyancy that occur during dive, such as from the compression of the neoprene in a diver's environmental protection suit, or from the consumption of gas in a dive cylinder. A means to add gas to a bladder in the BCD enables the diver's buoyancy to be increased, and vent valves allow gas to be discharged to reduce the diver's buoyancy through a reduction in the water volume displaced by the bladder.

Independent vent valves are fitted to almost all BCDs but are rarely used: the diver tends to favor a composite inflator/dump hose, usually mounted to the left side of the BCD. As such, the poor reliability of these valves has not been problematic in product sales, but it is not known to what extent reliability problems result in accidents. Between one third and two thirds of all SCUBA diving accidents are due to buoyancy compensation issues, based on SCUBA accident data published by DAN and BSAC. The reliability of the valve is therefore a prime concern even though the vent valve is used rarely.

The vent valve performs two or three different functions:
1. The valve acts as an over-pressure valve, such that the valve lifts with a pressure greater than that of the hydrostatic diameter of the bladder, then allows gas to vent such that even if the user adds gas continuously to the bladder, the bladder does not over-pressure. This requires a high flow rate through the valve, much higher than the maximum flow rate from the gas addition system.
2. The valve acts as a manual dump valve to allow the user to dump gas from the bladder. This again requires a high flow rate so the user does not have to keep the valve open for long periods.
3. In automatic buoyancy compensators, a third function is required, that of allowing a controller to open the valve under pneumatic, hydraulic or electrical control. The optimal flow rate for this application is usually close to that of the gas addition system, that is, a low flow rate.

Contemporary vent valves often fail to reseat correctly. The causes of incorrect reseating in BCD vent valves are primarily:
1. The compression spring in contemporary valves apply an uneven force to the valve plug, causing it to move at an angle to the axes of the valve seat;
2. The spring attached to the valve plug allows the plug to move from side to side, and may settle on the valve seat when off-center;
3. If the vent is operated in a jerky manner, the spring that pushes the valve plug against the seat can jump out of the retaining channel that keeps it in position, causing further misalignment of the valve plug with respect to the seat.

Various attempts have been made to improve the reliability of BCD valves, including by:
1. Fitting a wave spring instead of a normal compression spring that can reduce the angle at which the valve plug moves in relation to the seat;
2. Use of a deeper channel to keep the spring in the seat. However, the valve plug is still free to move at an angle to the seat, hence the chance of incorrectly seating, and again the spring can oscillate and move out of its channel given a suitable stimulus.

Some applications require the vent valve to be operated from a buoyancy controller. For example U.S. Pat. No. 6,217,257 describes a vent valve that is driven by a pneumatic piston. In the FIG. 1 of that patent, the valve plug moves on a piston, but the sharp edge of the plug shown can reduce the reliability of the valve because when the compression spring applies its force to the plug, the force is not even over the circumference of the spring so one side of the plug is pressed down towards the seat with greater force than the opposing side even though the compression spring contacts both sides on the exterior surface of the plug. That is, the addition of the pneumatic piston arrangement can reduce significantly the reliability of the valve, even though it tends to reduce the side to side movement of the plug.

In applications where a vent valve is operated by a buoyancy controller, it is usually desirable to have a flow rate that is substantially less than that of the same valve when it acts in an over-pressure or manual dump role. A valve that has two distinctly different flow rates, each of which can be set independently at the design stage, is highly preferable to one that has only one rate.

If a volume of gas is in a bladder underwater, then the gas will not flow out of a vent in the bladder unless the vent is higher than the gas: gas does not flow from a low pressure to a high pressure region on its own. In almost all circumstances where the diver wishes to vent gas, the diver's head is above the horizontal, so a single vent valve mounted on the shoulder may suffice as the gas will be near the diver's head when it is required to be vented. In other applications, two, three or more vent valves may be fitted to ensure the diver can vent gas in all circumstances.

The drawback of having a plurality of vent valves is that in the event of an undesirable increase in buoyancy, the diver may have to try each valve in turn in order to identify which one releases gas. Not all the valves may be easily reachable. Where a plurality of valves is fitted, it is desirable to have a method to open all the vent valves simultaneously. It is obvious that if more than one vent valve can be open at once, then one-way valves have to be fitted to prevent water ingress.

In water the ambient pressure will tend to collapse a bladder such that even if the gas is at the same ambient pressure as the vent, it may not flow to the vent unless there is an open gas path from the region containing the gas to the vent. Such gas paths may be kept open within a bladder by fitting a spiral or spring inside the bladder.

The prior art includes various devices that link together multiple pull-cords.

U.S. Pat. No. 6,217,257 describes a diver's buoyancy device with multiple vent valves that are controlled pneumatically, with one-way valves to prevent water ingress.

U.S. Pat. No. 6,217,257 describes the control means to actuate the valve as being a push-button which provides a pressurized gas supply to a piston that lifts the valve. It does not describe how the pressure is released: the patent appears to provide no means to release the pressure. That is, operating the button described in the patent would pressurize the pneumatic line to the vent valve, which in turn would cause the valves to lift, but there is no means to release the gas pressure in the line described so the valve would remain lifted and the buoyancy bladder would lose all its contained gas.

Another limitation of the prior art, such as in the form of a vent valve in U.S. Pat. No. 6,217,257, is that the addition of a pull-cord is not feasible to the form described because the cord would normally feed through the device for which a gas tight connection is required for operation of the device in FIG. 2 of U.S. Pat. No. 6,217,257.

Yet another limitation of the prior art, such as U.S. Pat. No. 6,217,257, is that a loss of pneumatic power would result in the valve becoming inoperable.

Yet another limitation of the prior art, such as U.S. Pat. No. 6,217,257, is that it is not possible to open the valve manually because if the pneumatic supply is shut, moving the valve would involve pulling a partial vacuum manually. This aspect would also prevent the valve acting as an over-pressure valve. That is, the valve described in U.S. Pat. No. 6,217,257 may operate as a pneumatically actuated valve but would require separate and parallel valves to provide the over-pressure relief and that would add cost to the BCD.

The activation of pneumatic valves underwater invariably involves power from a gas cylinder, as the use of a flexible gas volume would operate the vents as the volume comes under increasing ambient pressure as the diver's depth increases.

PCT/IB2013/000581 describes a pneumatically operated valve that overcomes many of the limitations of U.S. Pat. No. 6,217,257 but it does not address the reliability issue, nor any method of providing a dual rate of flow: a high flow rate for the over-pressure and manually activated gas path, and a low flow rate for the pneumatically actuated gas path. The valve in PCT/IB2013/000581 would have a low reliability in an automatic buoyancy compensator because the valve would be actuated very many times and even a low rate of failure would result in a high rate of failure on a per dive basis.

### Object of the Present Invention

It is an objective of the present invention to provide a highly reliable vent valve for BCD applications that includes over-pressure and manual vent functions.

It is a further objective of the present invention to provide a vent valve where the valve plug returns to the seat in the same position each time it is actuated.

It is a further objective of the present invention to enable the valve to be driven by a pneumatic or hydraulic power to a BCD vent valve such that a loss of power causes the valve to fail in a safe state.

It is a further objective of the present invention to enable all the vent valves on a BCD to be opened or closed with a single action if required.

It is a further objective of the present invention to provide a vent valve suitable for use by an automatic BCD.

It is a further objective of the present invention to provide manual control of the valves in the event of loss of pneumatic or hydraulic power.

It is a further objective of the present invention to provide the ability to drive the valve from a pneumatic gas line such that when the line is pressurized the valve opens with a flow rate significantly lower than that when opened through the over-pressure valve or manually actuated.

### Safe Automatic Buoyancy Control Device

The buoyancy of divers may change underwater, such as from increases in ambient pressure compressing the gas inside neoprene often used by divers to provide thermal protection, or from the consumption of the gas carried in pressurized cylinders. Additionally, novice divers are typically over-weighted such that they require a matching positive buoyancy to be able to swim freely underwater. These buoyancy compensation requirements are commonly satisfied by the use of buoyancy compensation device (hereafter, BCD) in the form of an inflatable bladder into which gas is added or vented, such that the change in volume of the bladder displaces water equal in weight to the buoyancy offset of the diver.

Expert divers, including military divers, commercial divers or professional sports divers, can dive without any buoyancy compensation device at all: they weight themselves optimally, and can use either their own lung volume or the counterlung volume of a rebreather, to compensate for the small buoyancy changes during a dive. However, it generally requires many hundreds or thousands of hours of diving experience to do this level of buoyancy control comfortably, so the majority of divers choose to use a BCD to manage their buoyancy.

It takes tens or hundreds or hours of experience for the diver to use the BCD optimally: without that experience the diver may add too much gas at one time, or fail to add enough. If the diver loses partial or full control of their buoyancy, the diver may exceed their desired depth profile or accelerate towards the surface in a dangerous manner. The control of the BCD is complicated by Boyle's Law, which compresses the gas in the BCD during descent and causes the same gas to expand when the ambient pressure reduces during ascent, resulting in an inherently unstable positive feedback loop. In conditions where visibility is poor, or where the diver is trying to follow a free floating decompression profile without a close visual reference, it is difficult for the diver to control the profile yet at the same time it is particularly important that the diver follows the profile accurately. Failure to follow a correct depth or decompression profile can result in serious or mortal injuries from barotrauma, decompression sickness, narcosis, blackout, oxygen toxicity or drowning. Many divers find free-swimming buoyancy control so difficult, that they prefer to ascend or descend on a fixed line: an anchor chain, shot line or buoy rope. Serious problems often arise in the event the diver fails to find the line or the line becomes adrift.

Many different automatic buoyancy control devices have been proposed to overcome these safety problems or limitations of manual BCDs. The great majority of these prior art patents are concept ideas, for which a patent has been applied for or obtained without reduction to practice, and hence without discovery of the key problems that prevent these proposals from working. Moreover none of the prior art address the fundamental safety problems of what happens when a valve or controller fails. The result is, that even if the devices proposed could actually work, they would reduce diver safety rather than enhance it, by introducing many new failure modes which are not fail-safe. The Safe Failure Fraction of the proposals to date is close to zero (inherently dangerous), whereas for a commercial product to be viable it should be close to one (inherently fail safe).

Some automatic buoyancy devices have been developed and two devices are in the market. One device is for lifting objects, such as mines, in a controlled manner: this releases the contents of a very small gas cylinder into a bladder and then controls the rate of ascent by opening a vent valve: the gas is always at the top of the device so the vent valve placement is simple. U.S. Pat. No. 6,772,705 describes a lift device whereby the water level in a chamber is controlled. This is very similar to the commercially available and pre-existing mine recovery devices. These devices are impractical for a free-swimming diver.

A device is commercially available for the rescue of divers on oxygen rebreathers, whereby if a preset depth or time is exceeded, it releases the contents of a cylinder into a life-safer device that guarantees a head up position: the diver is assumed to be unconscious or dead at the point the device is activated. In this special application, the ascent rate is able to be limited because the position of the gas in the bladder is known as it designed to provide a head up position for the diver, and does not have to hold any set depth: the device takes the diver directly to the surface without any stops on the way.

No automatic buoyancy device for free-swimming divers is available currently despite very many attempts to create such a device, spanning decades. The obvious desirable features for a buoyancy control device for free-swimming divers are to provide a maximum depth limit, the ability to hold a set depth, to do a controlled ascent and follow a dive computer decompression profile. However, the inventions needed to implement these desirable features have hitherto failed to overcome the basic physical problems and as a consequence have been unable to be realized successfully. The problems in this application are much more difficult problems than simply returning a diver or mine to the surface at a controlled rate.

A BSc Thesis by Robert Dyer submitted in January 2001 to the Massachusetts Institute of Technology entitled “Development of an Automatic Buoyancy Device for Application in SCUBA Diving”, proposed an automatic BCD that had an inlet and an outlet on a bladder. This device would be able to vent gas only if the vent valve was uppermost. The vent valve incorporated a one-way valve, similar to some contemporary dry suit valves. A prototype of the proposed system did not work due to a combination of problems: the resolution available from the pressure sensors is insufficient for such a simple control system to work in practice and experiments were curtailed due to water ingress problems. The device as proposed created a series of fundamental safety problems for the diver including uncontrolled ascents.

GB patent GB798366A describes a device that closes off a gas injection means when a BCD has a reached a maximum volume of gas, and can also vent gas by a volume sensitive means, i.e. when the maximum volume in a BCD is exceeded. In fact, virtually all BCDs produced in the past 30 years have a means to vent gas when a predetermined volume is reached: the vent valves on BCDs are spring loaded such that when the internal pressure exceeds the lift pressure (i.e. when the BCD bladder is full), the BCD vents all additional gas. This feature forms part of the requirements incorporated into EN 1809:1997 as a basic safety requirement for divers' BCDs. The relief of gas once a maximum volume is reached is quite different to the problem of determining the volume of a bladder in its normal range: the prior art fails to propose a viable solution to this critical problem which is the basis of most attempts to provide a free-swimming automatic buoyancy control device.

GB24499495A describes a device that is a subset of the pre-existing and commercially available mine and incapacitated diver recovery systems, but GB24499495A and others such as US20021277062A and US201083373A, fail to include any workable means to regulate the diver's ascent rate of a normal diver's bladder, so once gas is injected into the bladder and an ascent initiated, the device would likely injure or kill the diver by an uncontrolled ascent as the gas in the bladder expands with reducing ambient pressure and further accelerates the diver toward the surface. There are many patents of this type, where the concept has neither been reduced to practice nor modelled mathematically, and as a consequence the inherent flaws or impossibility of the proposal have escaped the attention of the proposer.

An automatic BCD needs input valves and vent valves to add gas or vent gas from the bladder. The vent valves need to operate with a practical power consumption and in a way that allows the gas to actually vent: if there is just one vent then the gas will not vent in many diver attitudes because water pressure closes the gas pathway between the vent and where the gas is located within the bladder (the uppermost part of the bladder usually—what is “uppermost” depends on the diver's yaw and pitch). At least three vent valves are required to vent gas from a bladder that may be in any orientation, and for some bladder shapes, even more are needed to ensure an open gas path between where the gas is located and a vent valve that is at a lower relative ambient pressure—otherwise the gas will not vent from the bladder when required.

It is apparent that any number of vent or exhaust valves can be installed if one-way valves are fitted to each of them: without the one-way valves the bladder would flood as multiple ports would be open simultaneously. Such vent valves with one-way valves were fitted to some rebreathers from 1999. Similar valves have been available for dry suits (a diver's buoyancy compensation device where the bladder is integrated with the diver's thermal protection), for at least 25 years. The US patent application US2001036781A describes vent valves connected to ropes that allow multiple valves to be opened by means of a single action. It is well known therefore that multiple vent valves can be opened or closed on a BCD by a single action, and using one-way valves within the vent valve to avoid the bladder flooding. The US patent application US2002182013A is another example of a device for opening the inflation and deflation valves and describes a means to operate a plurality of valves manually.

One problem with the use of multiple vent valves is the power required by some of the proposals. Basic safety requirements, including those incorporated into EN 1809:1997, requires that the vent must open at a low enough pressure and with sufficient flow such that the maximum rate of gas addition to the bladder does not cause the pressure inside the bladder to exceed a limit that is half the bladder's burst pressure, but the opening pressure must exceed the hydrostatic pressure of the bladder diameter in water. These two requirements give the spring force and amount of movement required. Mathematical modelling of the systems reveals that the response time required is in the order of 20 ms. Combining these three requirements reveals that the power needed for an electrical solenoid, such as that referred to in U.S. Pat. No. 5,482,405A, would be around 15 W per vent. When several electrical solenoids are activated simultaneously, the combined power consumption would be 45 W: such power is not available without large batteries such as those used for underwater lighting. It is certainly not available in a small dive computer as some of the proposals suggest.

Pneumatically controlled vent valves are known but are not used hitherto for automatic buoyancy control. Pneumatically controlled vent valves have been in use previously in some submarines, for controlling buoyancy. U.S. Pat. No. 6,217,257 describes a BCD where there are multiple vent valves controlled pneumatically, with one-way valves to prevent water ingress. Such a valve is suitable as a vent for the present application.

The problem that needs to be overcome by a practical automatic BCD is that of determining how much gas to add or vent from the bladder, which equates to the problem of how long to open an injector valve or vent valve. The prior art describes three methods for doing this, none of which work either in theory or practice. These methods are: 1. Measuring the ambient pressure and doing some undisclosed calculation. 2. Measuring the flow of gas into or out from a bladder, again doing some undisclosed calculation. 3. Measuring the bladder volume by measuring the strain on the bladder.

WO 99/37534 is an example of a concept patent which makes very broad claims for a device that has the obvious features desirable in an automatic buoyancy control device, including preventing a diver from exceeding a pre-determined depth, and for controlling the ascent rate, based on depth detection and CPU calculations. There are no depth detection and CPU calculations in that patent application and there is no known means to provide the features described with even current technology using the structures described in that patent. For example, the accuracy and resolution required from a depth sensor to provide a set depth where the data is ambient pressure, is 28 bits. No depth sensor, or even Analogue to Digital Converter (ADC) suitable for use on a portable piece of dive equipment, has ever come close to this resolution. There is no solution to the fundamental problem of the positive feedback loop that the process it describes of adding gas and then monitoring depth. In the drawings in WO 99/37534, there is only one vent valve and it is positioned at a point whereby if the diver is prone or head down, no gas would be vented. The device described in WO 99/37534 has many other problems, including it is inherently unsafe in that it describes valves where the malfunction would result in a total loss of buoyancy control and no means to switch them off. U.S. Pat. No. 5,482,405A is a similar patent, describing a “counter-balancing device” but it is actually nothing to do with counter-balancing, but is a diver's buoyancy compensation device. This is not reducible to practice due to the same fundamental theoretical problems of WO 99/37534, and has other problems such as having only one vent valve so if the diver is in some orientations it would fill the bladder without any means to vent the gas, resulting in the diver shooting to the surface. U.S. Pat. No. 5,482,405A seeks to control the rate of ascent or descent. This adds gas to the bladder if the rate of ascent or descent exceeds a limit and claims to be able to control a preset depth. There is no control algorithm of any sort disclosed other than oblique reference to what is assumed to be a bang-bang controlled. A simple bang-bang controlled that injects gas if the descent rate is too high, or releases gas if too low, is not able to control the diver's depth accurately without an unreasonable precision from the sensors.

U.S. Pat. No. 5,496,136 and U.S. Pat. No. 5,746,543 are examples where inventors try to control the buoyancy by a means involving determining the volume of the bladder by measuring the flow into and out of the BCD. How these flows translate into actual control of the inlet and outlet valves is not disclosed. The concept of measuring volume by measuring the flows does not work in practice, because any error between an input and output flow sensor accumulates in the integration process that is essential to estimate volume, and then subtracting the two integrals results in such substantial errors as to make the implementation impossible. In a typical BCD with 20 liters maximum volume, a 1% error in the integration differentials would amount to an error of 200 ml even the first time the gas is injected, and then this error would increase linearly every time gas is injected or vented. An error in buoyancy of 200 ml is more than enough to send the diver to the surface or sink the diver, let alone the error of liters that accumulate in the integration process with flow sensors. These flow metering patents also generally omit any reference to the fact that it is necessary to have at least three vent valves to enable the gas in the bladder to be vented in any orientation when it is attached to a free-swimming diver. Each of the three or more vent flow valves would have to be flow metered and the sum of the errors further compound the difficulties in implementing such a system.

The inventors of DE 4,125,407 realized that volume of gas in a bladder also depends on the temperature. Due to the large surface area of a bladder the temperature of the gas in a bladder will generally differ considerably from the temperature it is injected at. Moreover, the act of reducing pressure of a gas in an injector also changes its temperature. There is no solution in DE 4,125,407 to the fundamental problem of the errors that accumulate when deriving a parameter that is the difference of two large integrals. There is also no solution to the problem that changes in ambient pressure will also cause the volume in the bladder to change, dramatically.

It is possible in principle to measure the bladder volume by developing sensors that detect the strain on a bladder, but the gas in a bladder moves around depending on diver orientation, and the diving cylinders and other apparatus restrict the volume of bladder in an uneven manner, and press on the bladder, so this too does not work in practice.

In US patent applications US20033231932A and US20033075096A, the inventors seems to recognize the need to dump gas during the ascent, and then propose a system whereby the gas added and vented from the bladder is metered. To control the diver's depth to a decompression stop, requires the invention of a sophisticated control algorithm which is not disclosed. Mathematical modelling of the metering system proposed in that patent reveals that the ADC resolution required is 28 bits or more: again this is not feasible using current technology. There are other aspects of this patent that are of a concept nature, but are not capable of reduction to practice without some other undisclosed invention. A typical ambient pressure sensor generates a 0 to 1 Volt signal over a pressure range of 0 to 10 bar (equating to 0 to 100 m of water depth if the salinity is zero and the water density is 1 kg/liter), then the speed of the diver ascending at a rate of 10 m/minute would generate a signal of 1.67 mV per second, and the acceleration of the diver would be a full scale signal which is an order of magnitude or more less than this. The signal is of very low frequency, so is in the part of the frequency spectrum with the most noise. Even disregarding noise, the acceleration signal full scale would be less than the least significant bit from a 20 bit ADC that digitizes the ambient pressure sensor signal. In order to provide adequate control, at least 8 bits are required, and generally 10 bits. Adding these requirements together reveals that the data would have to be quantized with 28 bit to 30 bit accuracy. Mathematical modelling shows that a loop delay of under 100 ms is required so the data acquisition time should be ideally less than 10 ms. There is no ADC anywhere close to this performance level available as a part suitable for integration into a portable dive system, neither is the means to create such a part disclosed: a critical problem preventing the use of pressure data directly.

The patent US2003003075096A refers to a function to “Initiate 1st rate of ascent” or “Initiate 2nd rate of ascent”, without describing how such a function is achieved. To initiate an ascent is trivial: just add gas to a bladder. However, to initiate a particular rate of ascent is a complex process as will be apparent from the present patent application. A particular rate of ascent certainly cannot be achieved just by monitoring the input and output gas from a bladder, as the bladder expands during ascent, or deflates during descent due to the action of Boyle's law, as well as due to temperature effects. Similar comments can be made regarding U.S. Pat. No. 5,560,738 and DE 41,254,071 and SE 526,907C.

In most of the prior-art if the diver is head downwards, then the gas in the bladder would not be released, because the gas would be above the vent valve and gas does not flow from a low pressure to a high pressure region on its own: again the result would be an uncontrolled ascent to the surface.

The US patent U.S. Pat. No. 6,039,043 describes a multi-chamber BCD that is manually controlled. This is not practical for an automatic BCD because for each bladder, to vent gas in any diver orientation would require at (east 3 vents such that one vent is always above the gas centroid. To manage this with multiple bladders would require multiples of these three vents. Also the moment imposed on the diver by moving the gas centroid of the bladder within the region of the bladders results in insufficient acceleration on the diver to change attitude at any useful rate. Other patents, including WO 05/002674A, U.S. Pat. No. 6,203,246B, US2010003083, also describe BCDs with multiple bladders, but in the current context of an automatic buoyancy control dive, the change in attitude by use of multiple bladders has such a low rate of acceleration as not to be useful. A well designed BCD should keep the gas in the right position such that the diver has a neutral attitude underwater.

An obvious desirable feature of an automatic buoyancy control device for a diver is that is should follow a dive profile from a dive computer. WO99/37534, US2003031515 and several others go to the effort to apply for patents of this feature even though they are in the pre-existing prior art, however there is no disclosure in any of the prior art, or in any these patents, of how an automatic buoyancy controller can work given this input and the problems outlined above. US2002182013A similarly discloses communication between a BCD and an external handheld controller, and DE 10,108,090 also discloses a control unit for an inflatable jacket, but there is no disclosure of how such a device can actually achieve automatic buoyancy control—no means to implement such a device was proven to work at the time of these patent applications and no control algorithm is given.

U.S. Pat. No. 6,666,623B1 includes some claims for a device for controlling the buoyancy of a diver jacket so as to control his rate of ascent. Two different rates can be selected; a second diver can override the setting in order to safely send a disable diver to the surface. This suffers from the same limitations as WO 99/37534.

In US 200210127062 there is a general description of a buoyancy controller operating apparently from the simple operation of rules to open and close injectors and vent valves. In practice such a system cannot control the diver's depth because the vent valves available release gas in “burps” or large bubbles, which in turn cause an oscillation in the diver's position in the water column. Similarly there is no reference to hysteresis in rule-only descriptions, which is needed even to control a simple emergency ascent. Reference is made in US200210127062 to a “Depth Control Device” being available, but no such general module was known nor is described for controlling a diver's depth.

There is a significant amount of other prior-art, which suffers from one or More of the problems outlined above.

It is a primary objective of the present invention to enable a diver's buoyancy control device to impose a depth limit.

It is a further objective of the present invention to enable a diver's buoyancy control device to limit the diver's ascent rate to a predefined rate or rates.

It is a further objective of the present invention to enable a diver's buoyancy control device to limit the diver's ascent rate to a predefined descent rate or rates.

It is a further objective of the present invention to enable a diver's buoyancy control device to hold the diver at a depth selected by the diver, diver computer or a predefined depth, for a defined time period.

It is a further objective of the present invention to enable a diver's buoyancy control device to follow a dive profile generated by a dive computer.

It is a further objective of the present invention to provide a high Safe Failure Fraction for such an automatic buoyancy control system.

It is a further objective of the present invention to provide manual control of injectors and vent valves using a means for managing failure compatible with the equivalent components of a manual buoyancy control device.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Buoyancy Vest Vent Valve with Reliable Seating

According to the invention, provided is a device for venting gas from a diver's buoyancy compensation bladder (“BCD”), the device comprising a valve plug configured to open or to close a valve seat, a spring configured to apply force to the valve plug to close the valve seat, a piston configured to apply force to the valve plug to open the valve seat, and a manual pull dump configured to open the valve seat manually wherein the spring is fully restrained for more than 50% of its length, and the movement of the valve plug is constrained by a centering mechanism that prevents the valve plug from moving laterally or angularly while the centering mechanism allowing movement with the face of the valve plug parallel to the valve seat along the axis of a line extending perpendicular to the valve seat under any combination of over-pressure or manual pulling action using the manual pull dump.

Thus, the present invention provides a vent valve that incorporates an over-pressure function, a manual over-ride function and, where required, a powered actuation function, each of which are available at all times to enable the valve to be opened through any one or more of these actions at any time. The valve plug returns to the valve seat when the valve is closed, without the possibility of it moving laterally (sideways across the seat).

According to an example of the invention, the valve plug is configured to be biased to open the valve seat by a pneumatically or hydraulically powered means enabling powered actuation of the valve plug and/or by the manual pull dump enabling manual actuation of the valve plug. And the valve plug is configured to be biased to close the valve seat by a counterforce created by or assisted by the spring providing the instantaneous flow rate from the powered actuation of the valve plug is lower than the instantaneous flow rate from the actuation of the valve plug through over-pressure relief or the manual actuation.

Preferably the valve plug is operable by the powered actuation to open first vent holes and the valve plug is operable by the actuation through over-pressure relief or the manual actuation to open second vent holes wherein dimensions of the first vent holes and the second vent holes define the instantaneous flow rates from the powered actuation of the valve plug and from the actuation of the valve plug through over-pressure relief or the manual actuation.

According to another example of the invention, a piston rod of the piston is configured such that in case of a loss of electrical or gas power the valve plug is operable by the spring to close the valve seat while the valve plug remains operable by the manual actuation.

Thus, the present invention can further provide a fail-safe means to operate the valve using any gas or liquid, whilst maintaining the over-pressure and manual actuation functions.

According to another example of the invention, the valve plug comprises an outer valve plug and an inner valve plug.

According to another example of the invention, the centering mechanism comprises a guide maintaining the valve plug such that the face of the valve plug is parallel to the valve seat at all times, wherein the guide is constrained by a cylinder that forms part of an outer cover of the device.

According to yet another example of the invention, the spring is restrained by walls arranged at the opposite ends of the spring.

### Safe Automatic Buoyancy Control Device

The present invention relates to devices, techniques and methods to manage the buoyancy compensation device worn by a diver, whereby gas is added to the bladder via an electrically controlled gas valve, and vented by the operation of pneumatically activated valves, in a safe manner. The control unit determines the period that the valves should be opened using an algorithm using inputs from sensors measuring depth and derivatives of the depth (the first derivate obtaining speed, and the second derivative the acceleration of the diver). The process combines an expert system type approach (conditions and actions), with a pulse width modulator (“PWM”) for fine control. The device uses a novel combination of sensors to obtain the ambient pressure, speed and acceleration of the diver within the accuracy and resolution limits of practical sensors and ADC converters.

The gas valves are arranged in a novel manner such that removal of the gas supply to the device, or removal of electrical power, leaves the manual control functions operational as a manual buoyancy control device, and whereby failure of any hose or actuator does not create an unreasonably dangerous situation for the diver.

A novel gas connection fitting is described that is able to tap the gas supply to the manual inflator to provide a gas supply for the actuators.

A novel control means is described for an automatic buoyancy compensator which sufficiently damps the natural positive feedback loop within a bladder, such that the ascent speed, or descent speed is limited, and the diver can hold a desired depth.

A novel gas vent device is described which enables the device to operate consistently, whether the powered gas piston is used to open the valve or if the valve is opened manually.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

Buoyancy Vest Vent Valve with Reliable Seating

FIG. 1 shows a vent valve according to the present invention in the state where the valve is closed.

FIG. 2 shows a vent valve according to the present invention in the state where the valve is open through manual actuation or over-pressure.

FIG. 3 shows a vent valve according to the present invention in the state where the valve is open through an automatic actuation channel only.

FIG. 4 shows a vent valve according to another example of the present invention in the state where the valve is closed through an automatic actuation channel only.

FIGS. 5-7 show the inflation and deflation of a buoyancy control device (“BCD”).

FIG. 8 shows an alternative example of SUBA configuration.

FIG. 9 shows an alternative example of SUBA as constructed.

### Safe Automatic Buoyancy Control Device

FIG. 10 shows an example of the overall configuration of the present invention onto a BCD.

FIG. 11 to FIG. 14 show the gas flow paths of an actuation means in a preferred example of the present invention in each of the four states where two solenoid valves are used to control the injection of gas into a bladder and into a fine bore hose to pneumatic vent valves.

FIG. 11 shows the case where both solenoid valves are closed on initial start-up.

FIG. 12 shows the state where the first solenoid valve is energized to activate the vent valves.

FIG. 13 shows the state where a second solenoid valve is has been energized and gas flows into a fine bore pneumatic hose that activates an exhaust valve.

FIG. 14 shows the state following that valve being subsequently closed and a residual gas is released into the bladder.

FIG. 15 shows a preferred arrangement of gas valves providing fail-safe features.

FIG. 16 shows the cross section of a device providing enabling a gas supply to be tapped off from a manual injector to supply an automatic buoyancy control device, leaving the manual injector functions operating as well as the ability of the diver to disable the device by unplugging the gas supply.

FIG. 17 shows a basic pneumatically activated vent valve according to the present invention which provides a consistent operating force and seating of the valve.

FIG. 18 shows the main four modes of acceleration drop for negative initial speed. Vectors of the positive waypoint, speed and acceleration direct to depth. Vectors of the negative waypoint, speed and acceleration direct to surface. IV mode includes the motion with/without speed limit.

FIG. 19 shows a block schematic generating speed and acceleration signal from a pressure sensor using analogue means, and combining part of a filter to reduce the effect of respiration on the data with the differentiator producing a speed signal.

FIG. 20a-20f shows a simplified control process example in the Ada language for controlling the gas injection and venting of a bladder to achieve accurate control of diver depth, enabling the diver to move from a current depth to a set depth without exceeding predefined ascent or descent rates, and also able to perform emergency ascents, controlled ascents and follow a decompression profile through changes to the Maximum Allowed Depth.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

The invention will now be described in detail by reference to the aforementioned drawings and by use of examples. Reference is made to a BCD bladder. The form of the bladder is not important: the present invention many be applied to many different types of bladders. The sole unique feature for the bladder to be used with the present invention is that the vent valves shall be arranged such that there is an open gas path from the gas in the bladder to one of the vents: at least one vent valve is typically required to fulfil this specification depending on the range of diver attitudes for which the vent function is available.

Buoyancy Vest Vent Valve with Reliable Seating

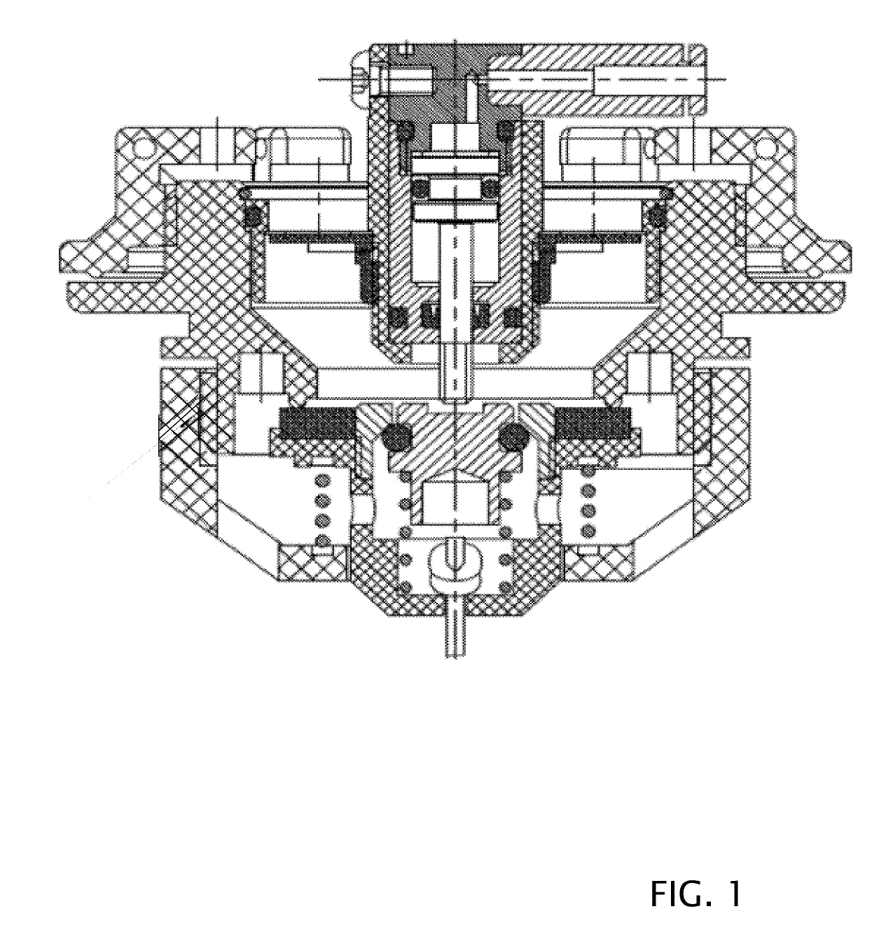

FIG. 1 shows a vent valve according to the present invention in the state where the valve is closed. The valve in this example and the following drawings includes a provision for powered actuation, which is desirable but not a necessary feature of the valve.

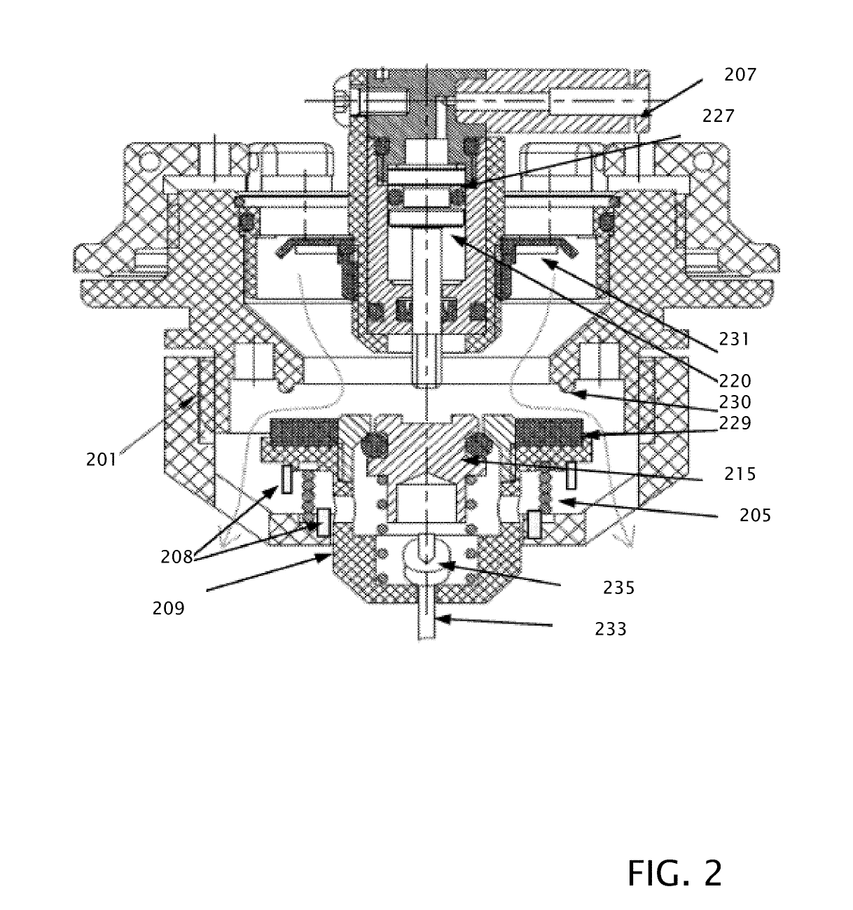

The vent valves in the examples shown in FIGS. 1 to 4 have a conventional manual pull dump (233) in addition to a pneumatically or hydraulically powered piston (227). The pull dump may be on a cord (235) or a lever. A spring (205) applies a pressure to a valve plug (229) to close a seat (230), but which can be over-ridden by any combination of manual pull action, over-pressure or in these examples the powered actuation of the piston. The vent valve shown in FIGS. 1 and 2 also comprises an inner valve plug 215; however, the vent valve according to another example shown in FIG. 4 comprises only one main valve plug 229.

A compression spring (205) is constrained by walls (208) for more than half its length, which prevents entirely the spring moving laterally (side to side in the drawings). The walls (208) can be arranged from opposite sides of the spring (205) or the walls (208) can have another configuration. The compression spring (205) may be a wire spring or a wave spring, or any other type of spring that applies a force to the valve plug (229) towards the direction of the seat (230).

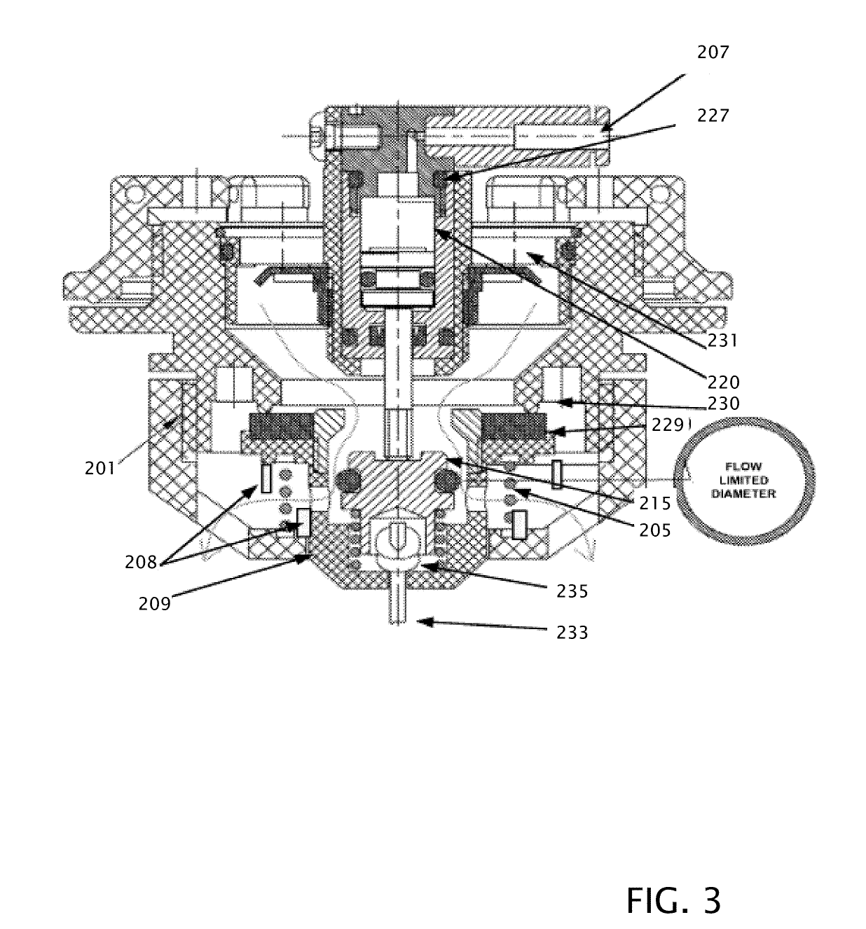

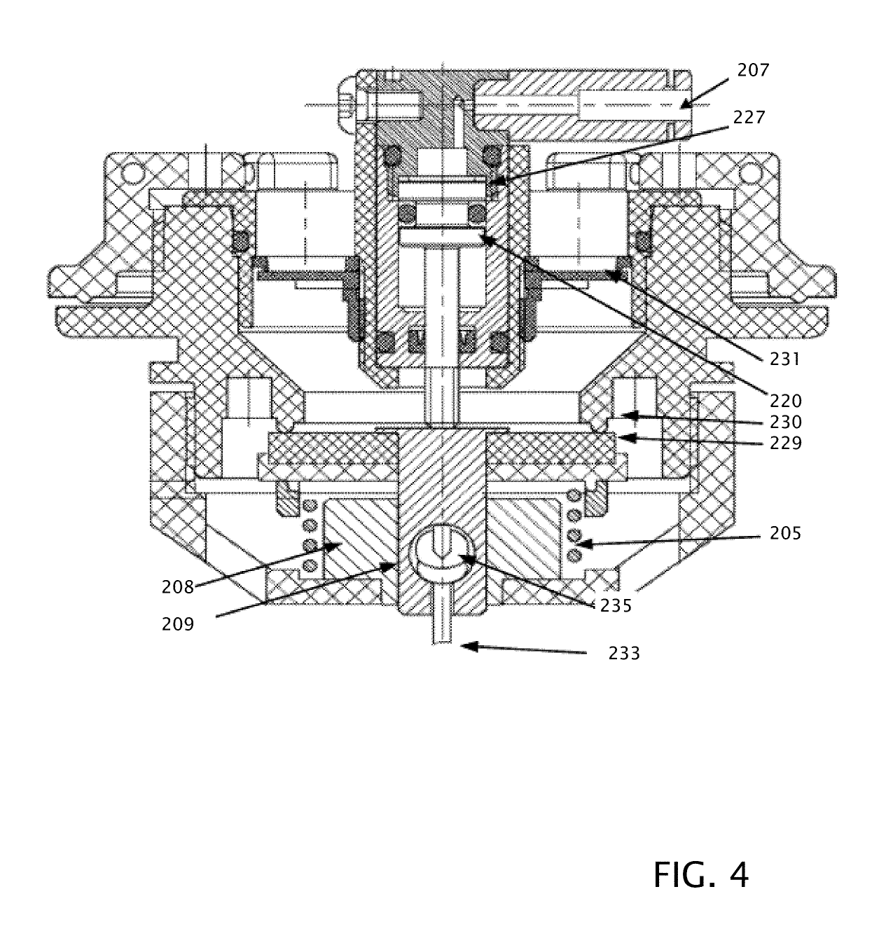

A compression spring (205) will apply an uneven force to the plug (229). Without further constraint, this would tend to allow the plug (229) to move at an angle with respect to the seat (230). To prevent that angular movement, the plug (229) is attached to a guide (209) that maintains the plug (229) such that the face of the plug (229) is parallel to the seat (230) at all times. In FIGS. 2 and 3 the guide (29) is constrained by a cylinder that forms part of the outer cover (201), and in FIG. 4 the guide (209) is constrained by the wall (208) that restricts the spring (205). It is highly preferable that the end of the guide remains outside the cylinder that it moves in, to prevent angular forces jamming the guide (209) in the cylinder.

A hose (207) carrying the gas from the inflator to the actuators is preferably a narrow bore hose. Kynar hoses are available with a 0.8 mm bore and an outer diameter of 3.6 mm, which have the effect of limiting the maximum flow rate when used with typical BCD gas supply pressures to around 20 liters of gas flow per minute, and have a burst pressure exceeding the gas supply cylinder high pressure, such that if the first stage cylinder pressure regulator were to fail, then the hose (207) would not rupture, and therefore there is no risk of the bladder in the BCD being inflated suddenly. Moreover, use of a very small bore hose means that should the hose break, the flow rate into the bladder is much lower than the minimum vent rate if the diver uses the manual vent controls on the vent valves.

A one-way valve (231) is preferably fitted, and the one-way valve (231) is preferably of an umbrella flapper valve construction to provide a positive cracking pressure to prevent water ingress into the BCD when the valve is open.

Vent valves with the features shown, namely an input (7), provide pressure in which causes a piston (227) to move, opening a plug or stopper (229), allowing gas in the bladder to escape through a one-way valve (231). A manual pull-dump (233) is preserved in the preferred example, allowing manual operation of the vent by the diver at any time. The pull-dump cord (235) may be singular or may be combined.

A novel feature of the vent valves in the preferred example is the use of a wave spring to apply even pressure to the plug (229) such that seats evenly.

The use of the wave spring reduces the difference in the spring force across the plug (229) and hence reduces the angle it tries to adopt with respect to the valve seat (230). A wave spring is a type of compression spring built from a series of thin washers that have a wave-like profile. Compressing the washers, which are normally welded together, results in having a reactive force that is even around the circumference of the spring. A wave spring can also provide a greater extension for a particular spring force and spring bound size than a conventional wire compression spring, which can be advantageous in this application.

A key feature of the vent valve is that the plug (229) is not firmly attached to the piston (227), such that pulling the plug (229) via the cord (235) causes the plug (229) to lift off the seat (230) without the piston (227) having to move. The seat at the top of the piston (227) need not be attached to the plug (229).

In all FIGS. 1 to 4, the valve plug (229) is not fixed to the pneumatic piston rod (220): the rod can push the inner valve plug (215) in the example in FIGS. 1 to 2 and the main plug (229) in FIG. 4, but does not prevent over-pressure from moving the plug to open the valve, nor prevent manual actuation opening the valve.

In the case of FIG. 4, the valve plug (229) is limited in its movement by adjustment of an exterior cap to the valve to provide a limited or restricted instantaneous flow rate. In that example the instantaneous flow rate through the over-pressure action is also limited in applications where that is desirable.

In FIGS. 1 to 3 the automatic actuation of the valve does not move the main valve plug (229), but moves only the inner valve plug (215), through which gas flows. The instantaneous flow rate through that secondary valve comprising the inner valve plug (215) and seat is defined by choice of vent hole dimensions. This enables the automatic actuation of the valve to use a much lower instantaneous flow rate than that when the valve is opened manually or through over-pressure. For optimum automatic buoyancy control a ratio 8:1 or 16:1 is desired between the instantaneous flow rate in the over-pressure role and the instantaneous flow rate in the power (automated) actuation role.

The pneumatic power may be provided by an arrangement of gas valves that apply a lower gas pressure, such as 9 bar, to the hose (207) to activate the vent valve, but which in the quiescent or inactive state opens the gas line to the BCD bladder. When the gas hose (207) is a small bore hose then the volume of the gas vented to the bladder may be kept to a negligible amount.

An alternative to the pneumatic power to activate the vent valve is by use of a bellows containing a liquid such as alcohol or water or silicone oil, and pressure on the bellows by the user causes pressure to build up in the hose (7) and the valve to be opened. The spring bias to the bellows causes the liquid to pull back the piston when the pressure is removed. The pressure may be through a lever or directly on the bellows.

The bellows or the hose (207) has a means through which gas can be drained and fluid topped up, but such means may be in the form of a nipple or filling point: there is no need for a hydraulic reservoir. During the filling process, sufficient provision should be made for the thermal expansion of the hydraulic liquid: this can be accommodated by a partial fill such that expansion of the liquid extends the bellows and contraction causes them to shrink in size, but leaving sufficient movement for the manual action.

The bellows may be implemented in a variety of forms, including a thick walled balloon such as a silicone molding, or it may be a telescoping molding, or it may be a series of telescoping elements with O-ring seals.

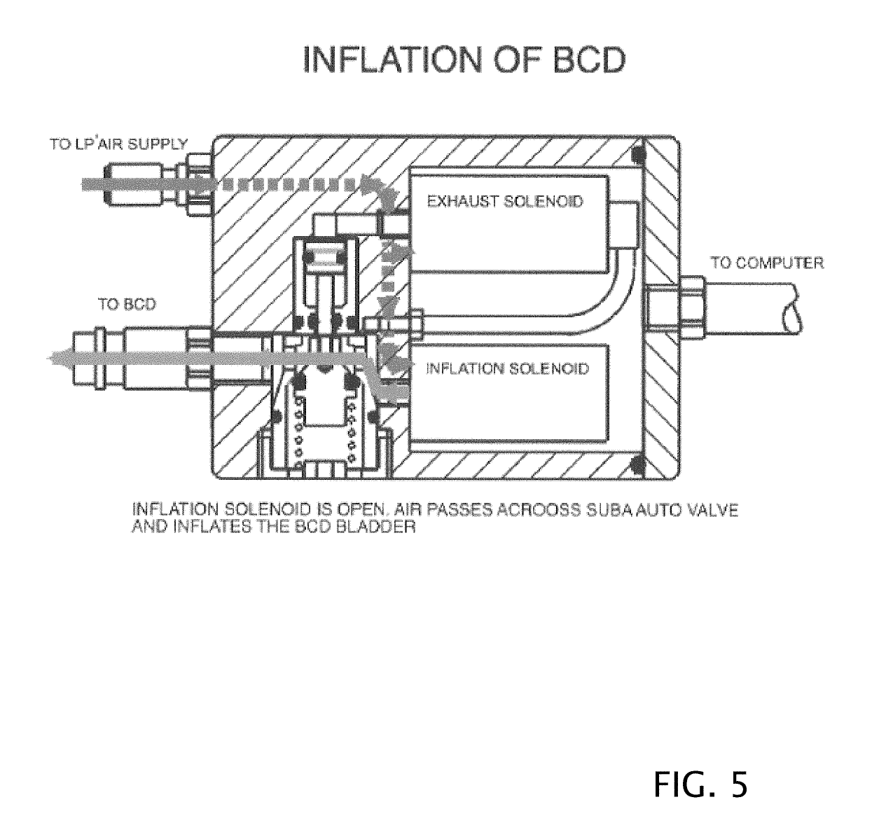

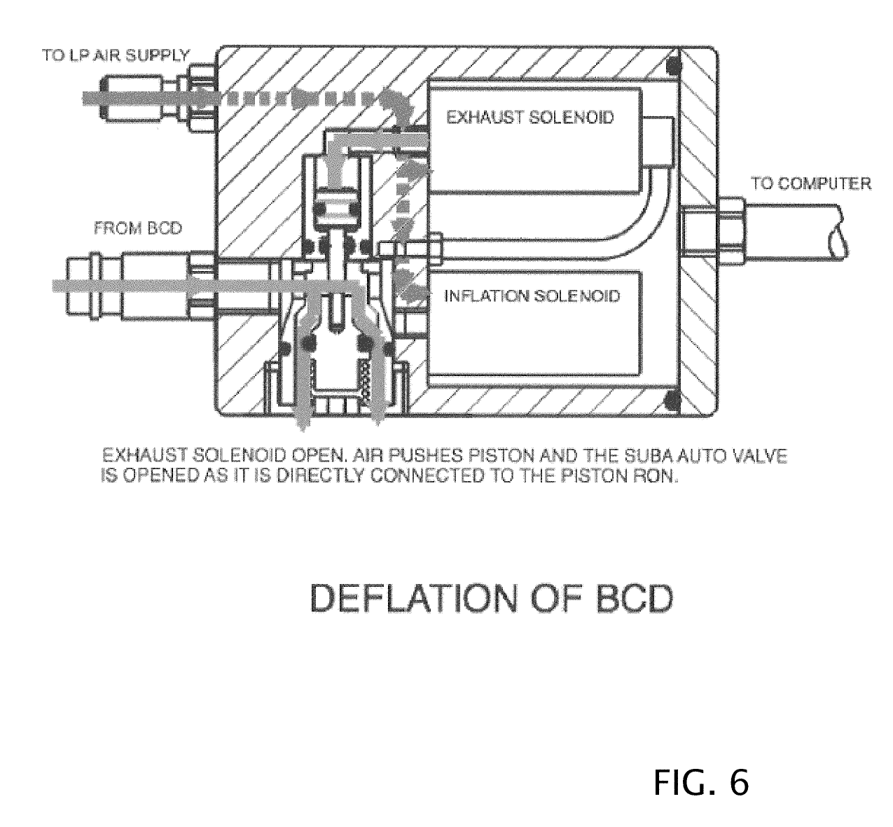

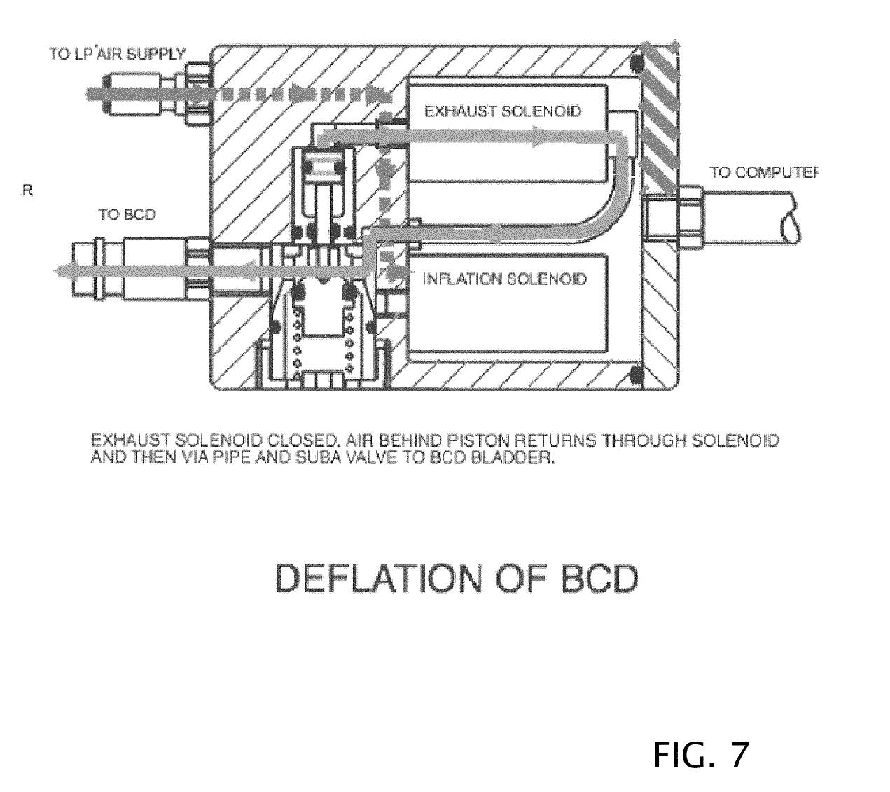

FIGS. 5-7 show the inflation and deflation of a buoyancy control device (“BCD”).

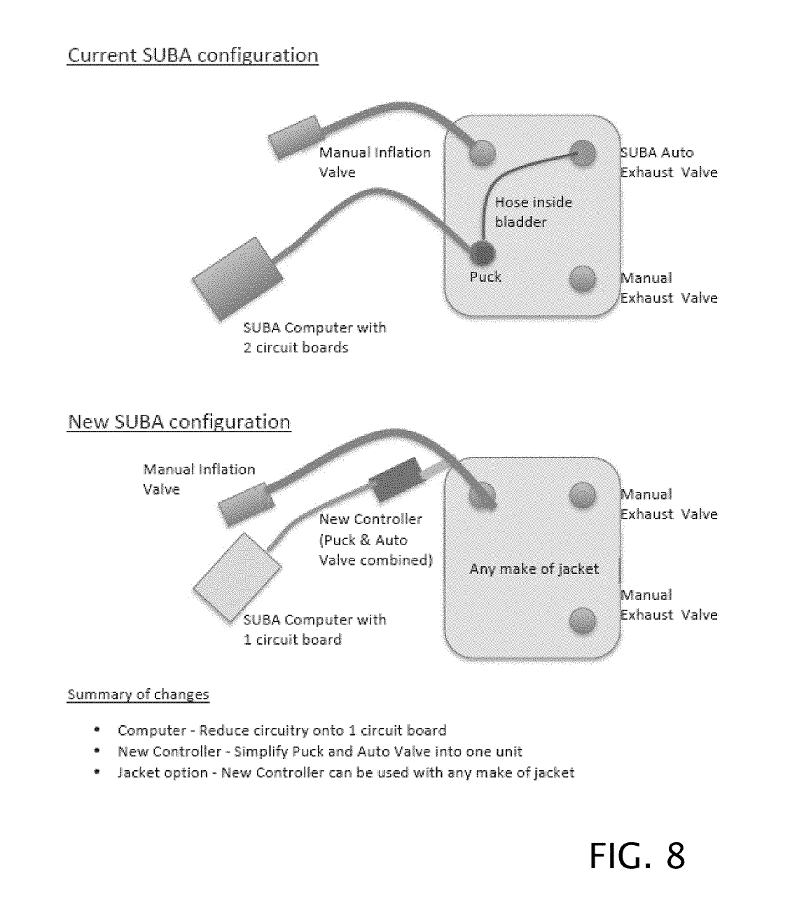

FIG. 8 shows an alternative example of SUBA configuration.

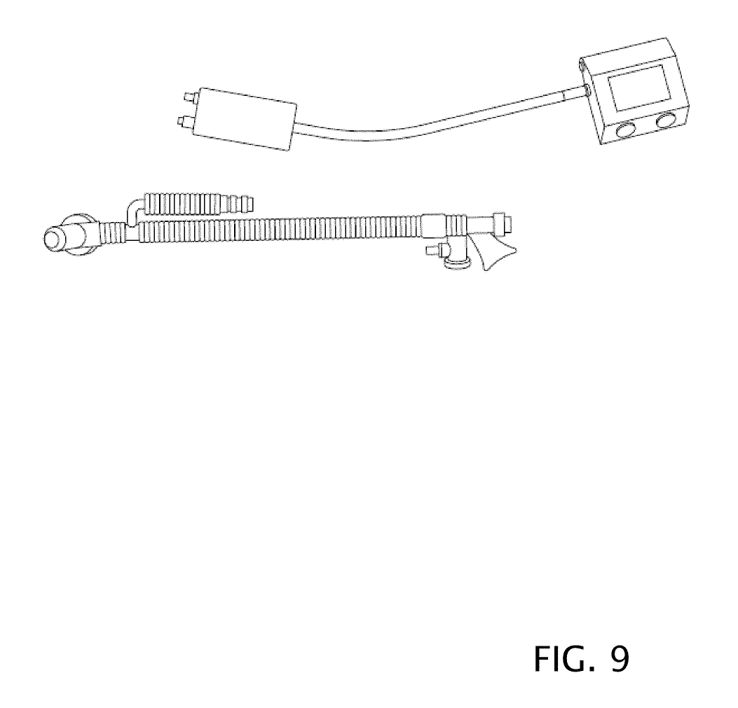

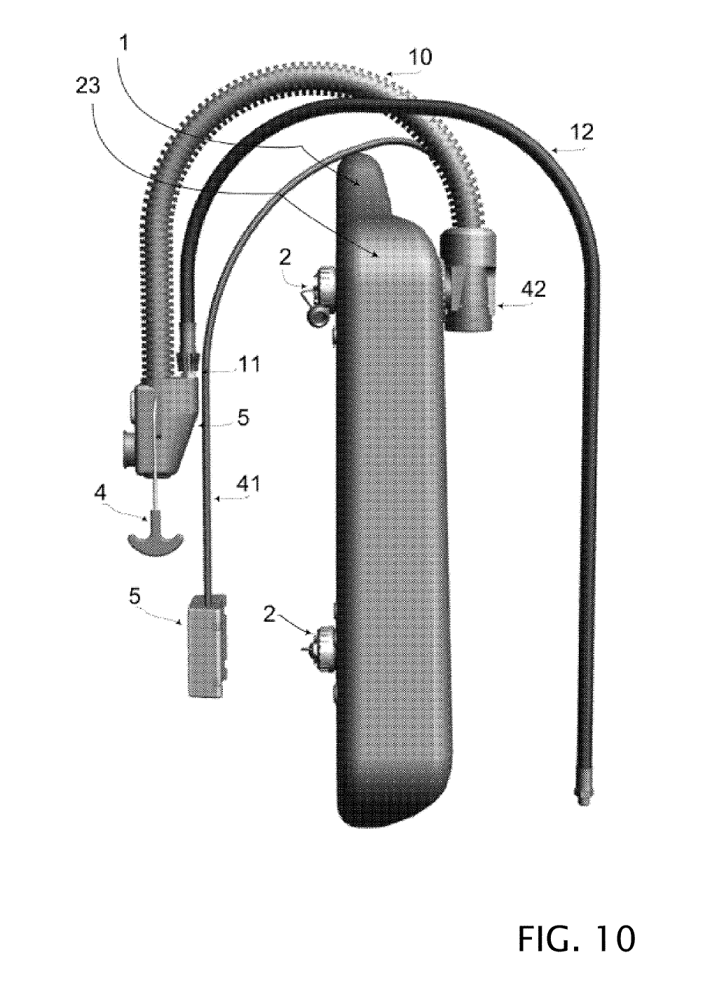

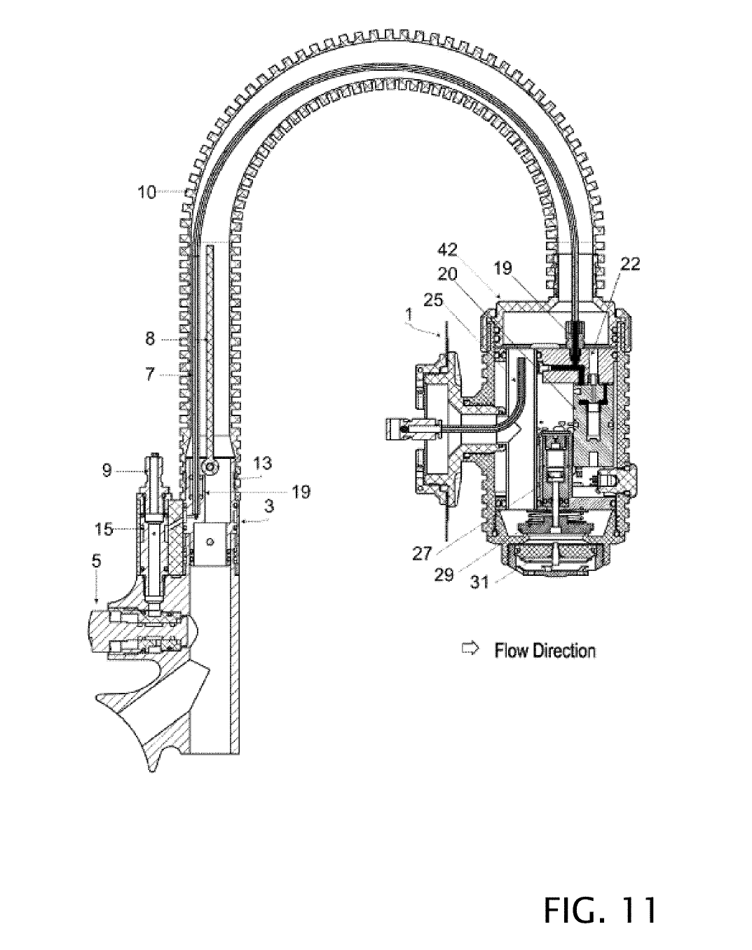

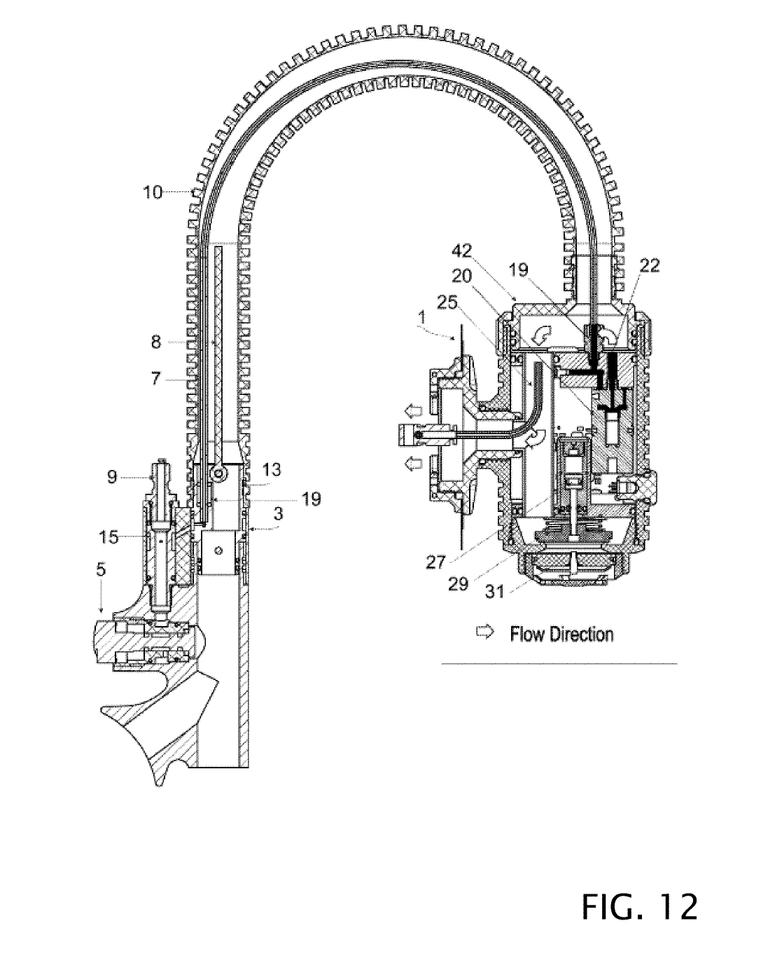

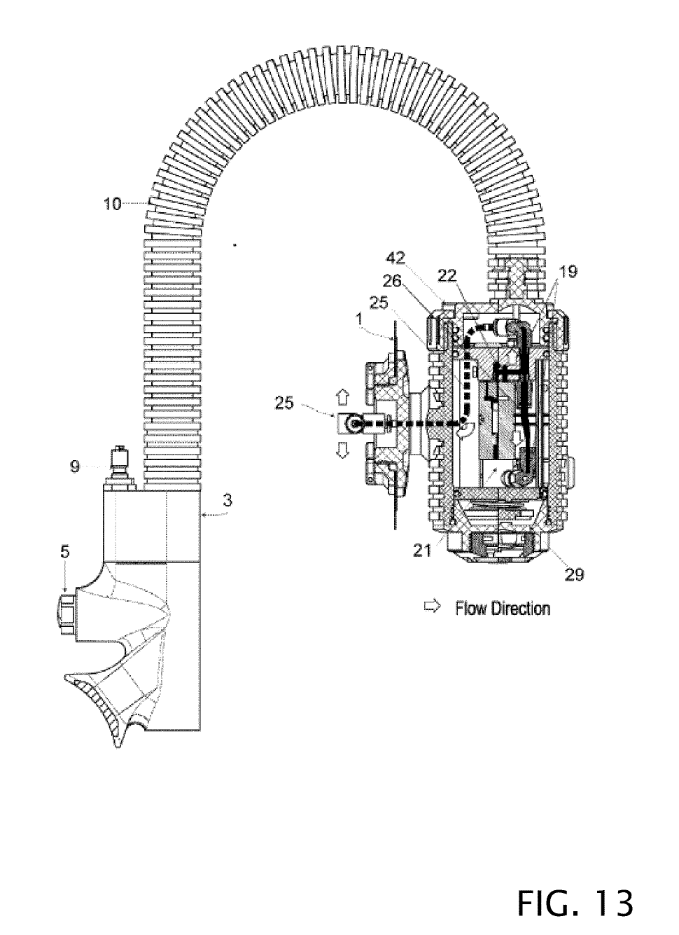

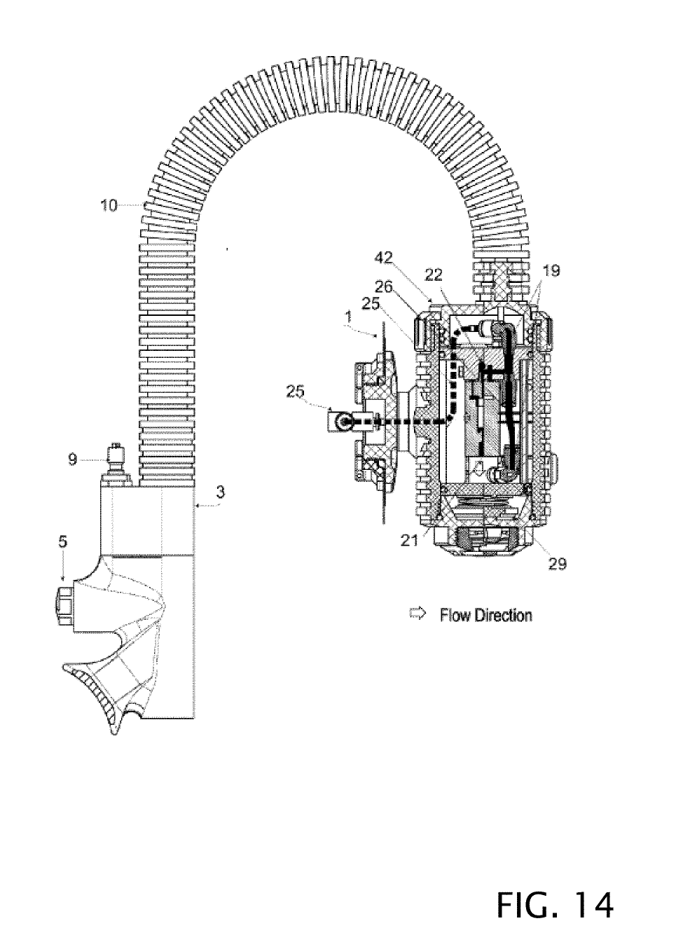

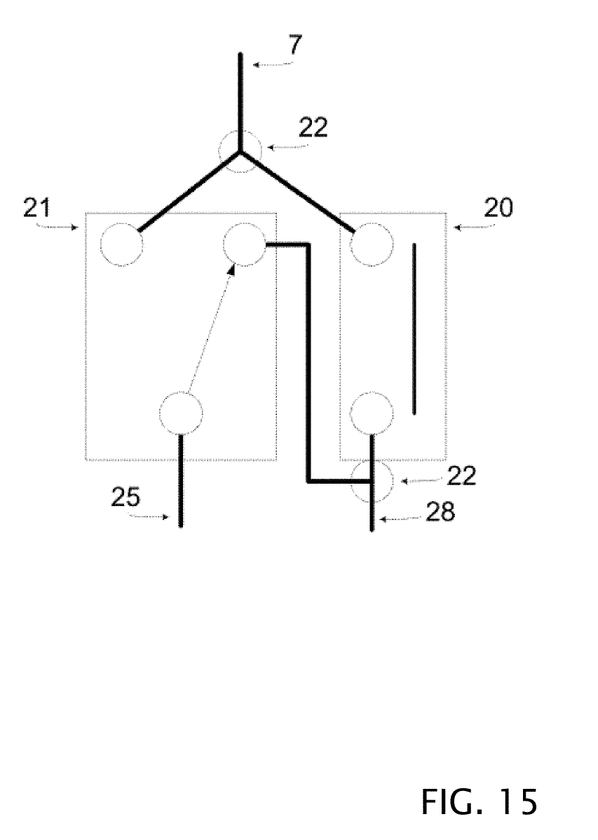

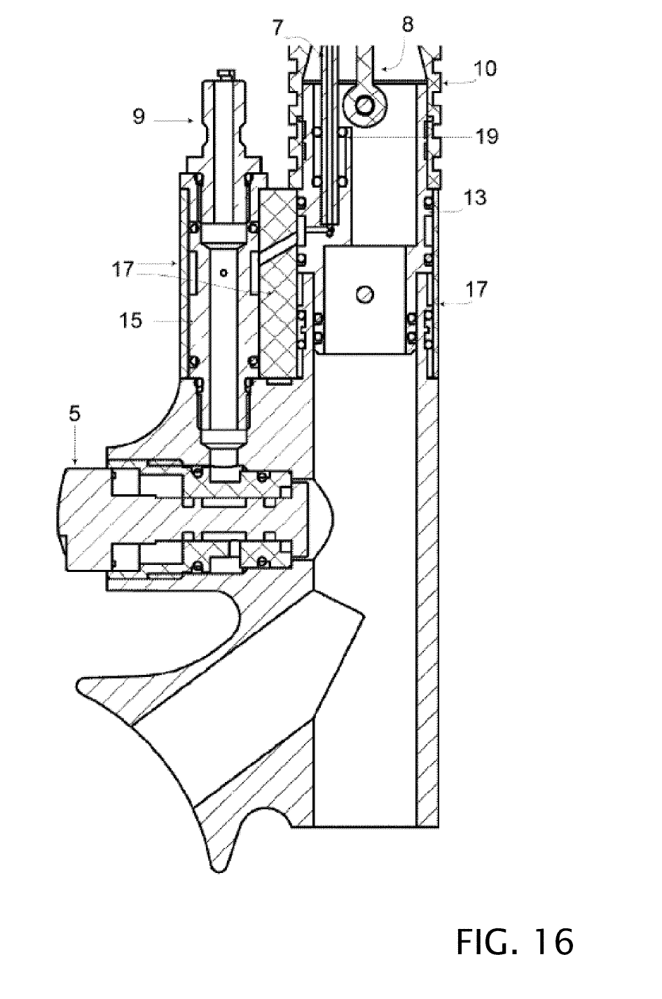

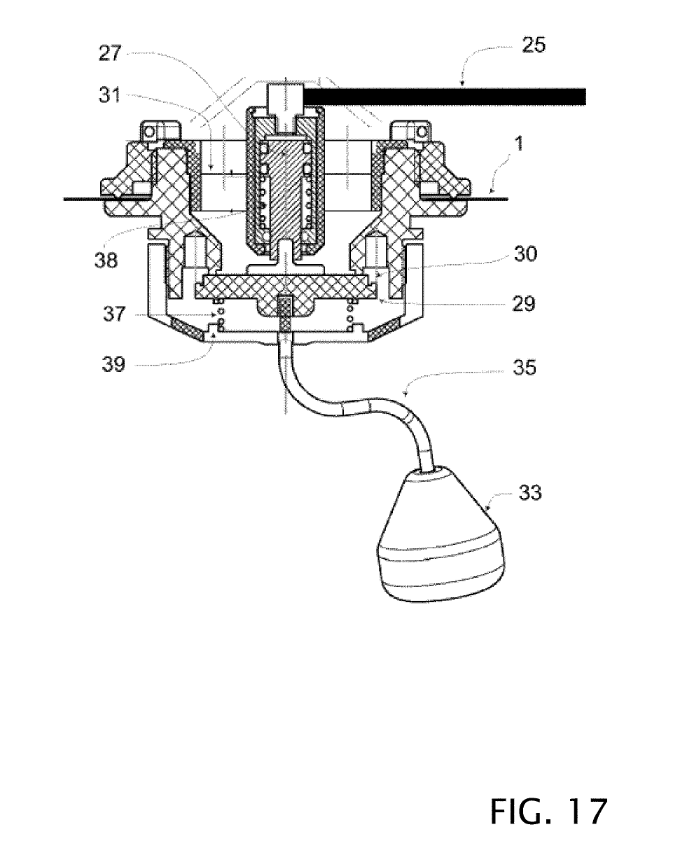

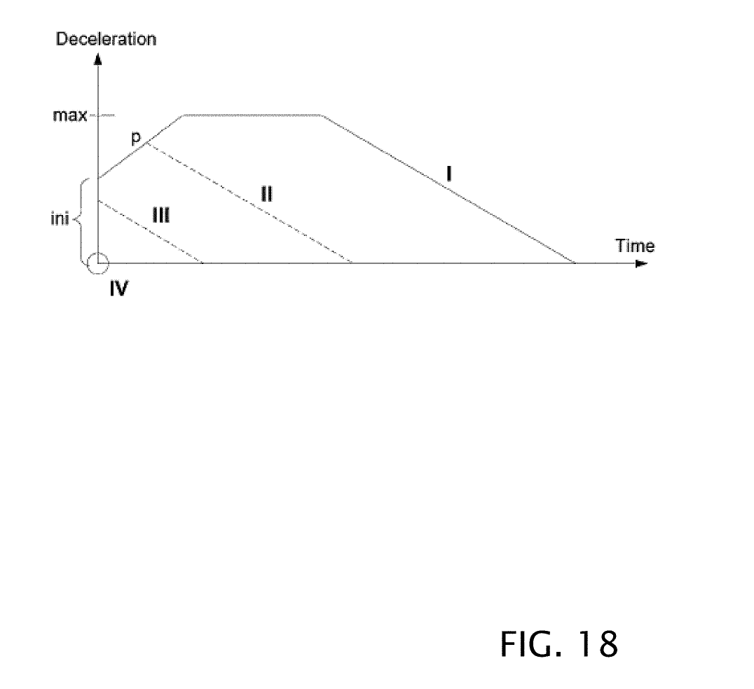

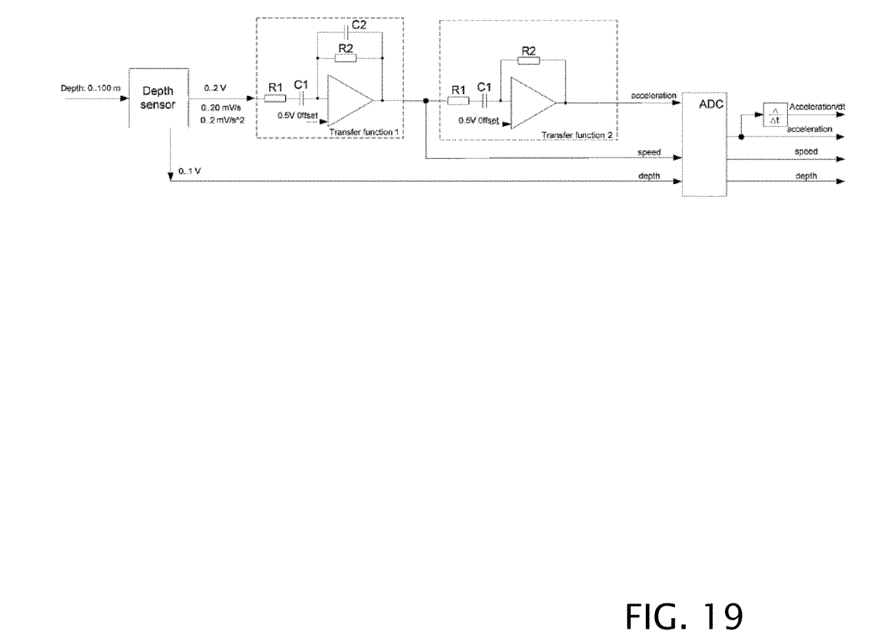

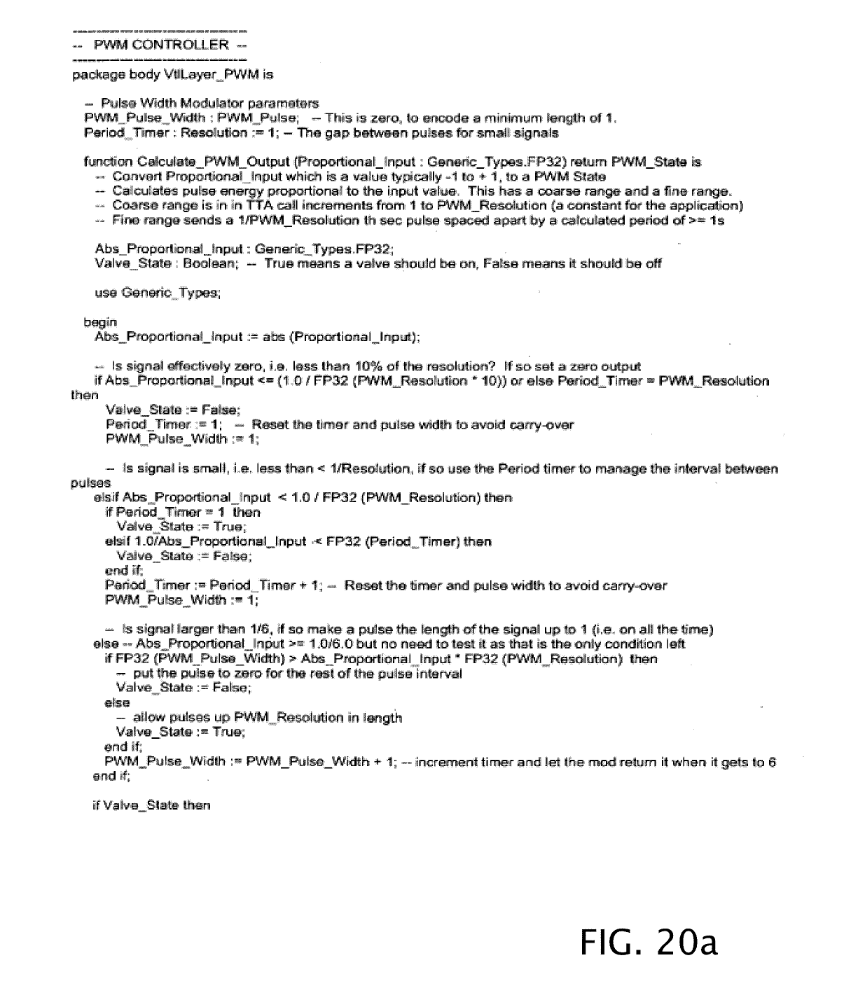

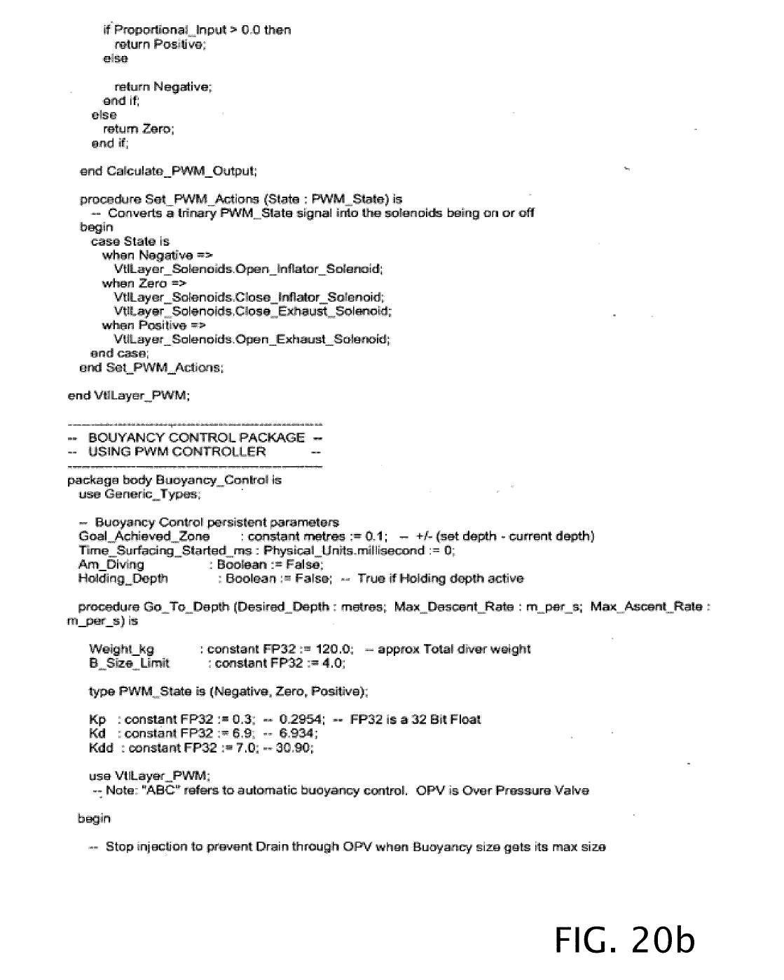

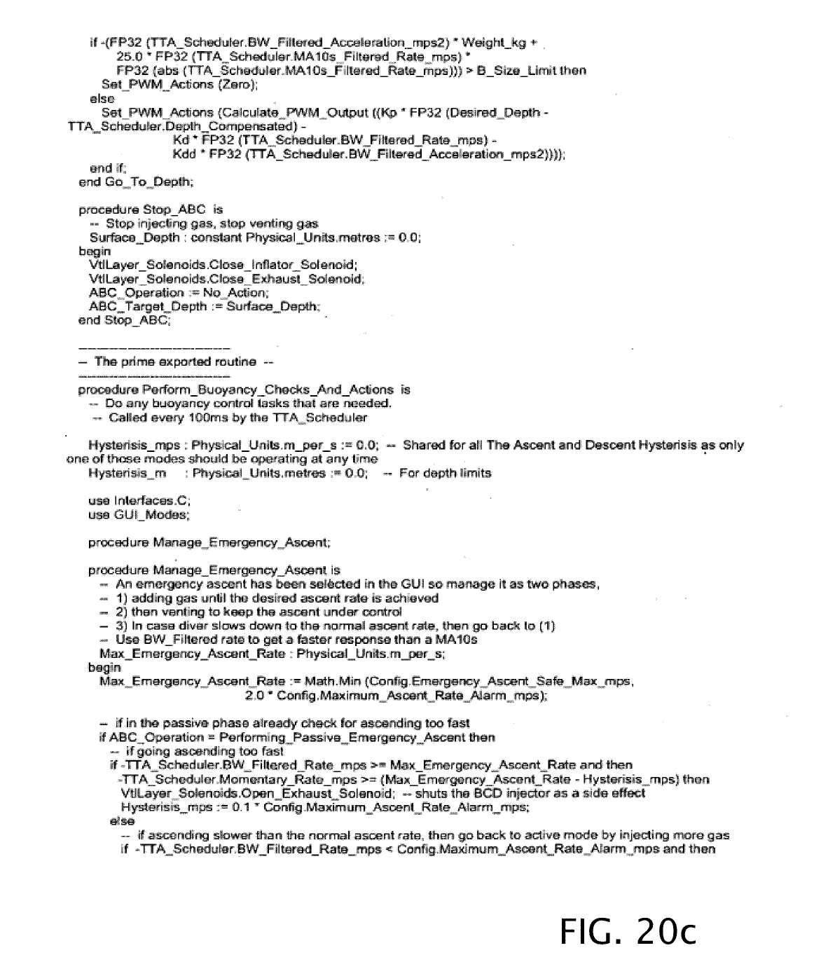

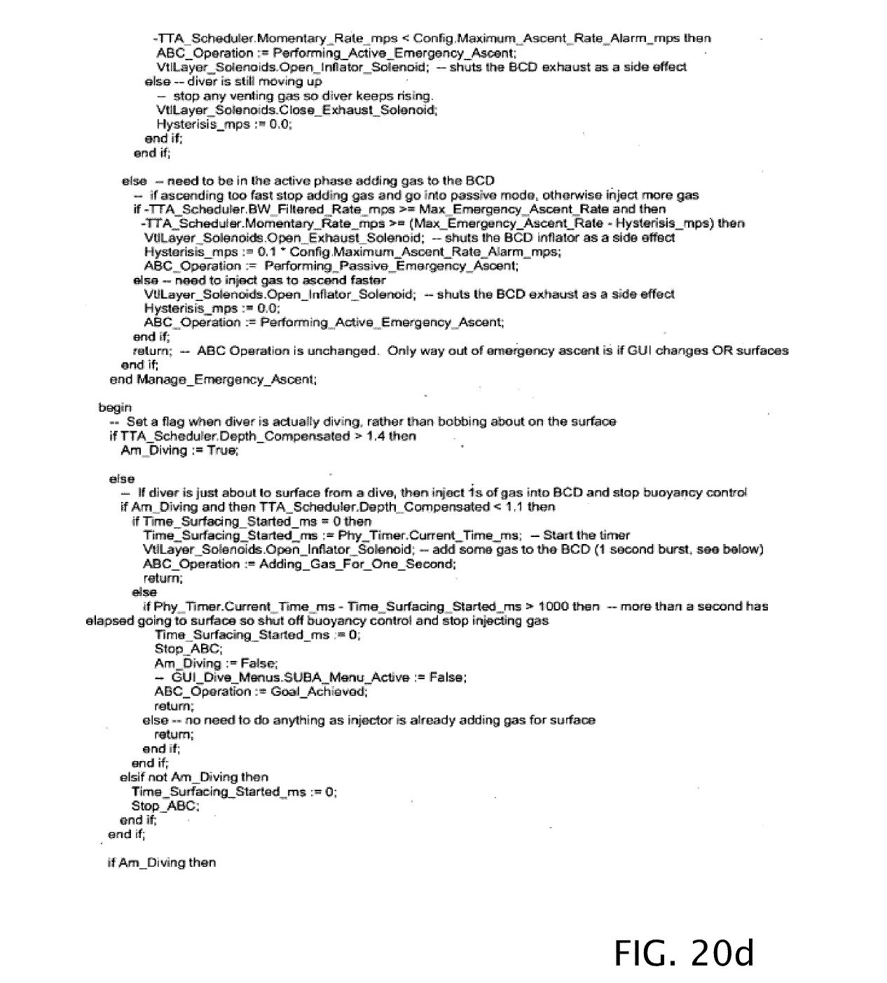

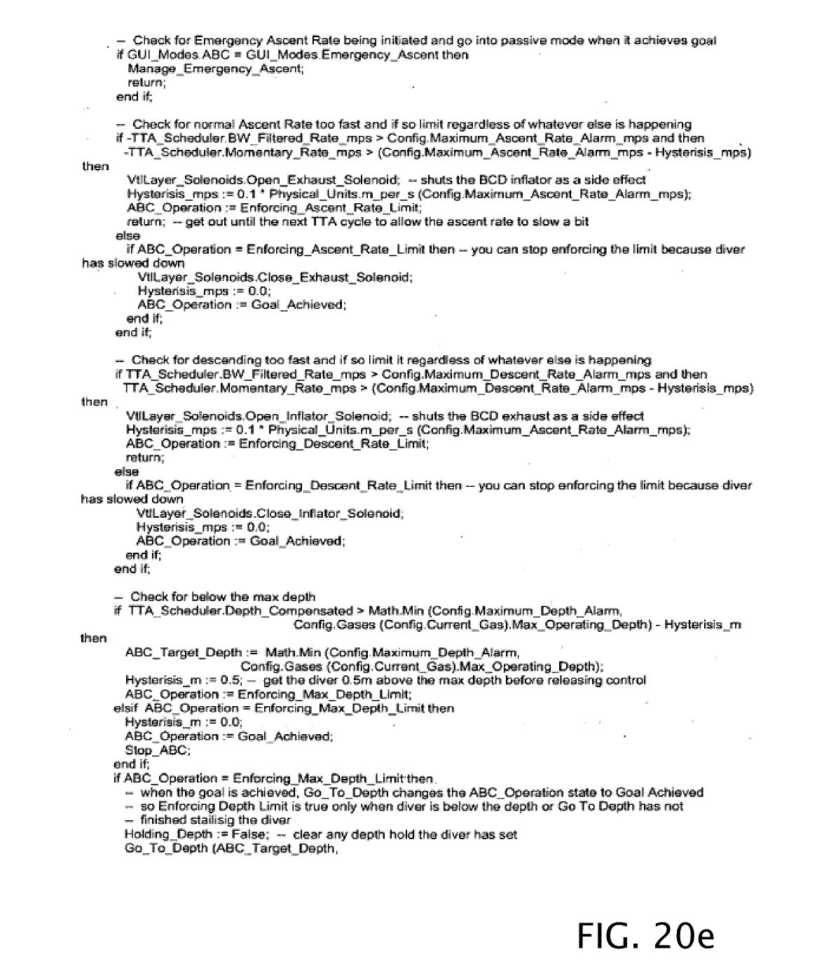

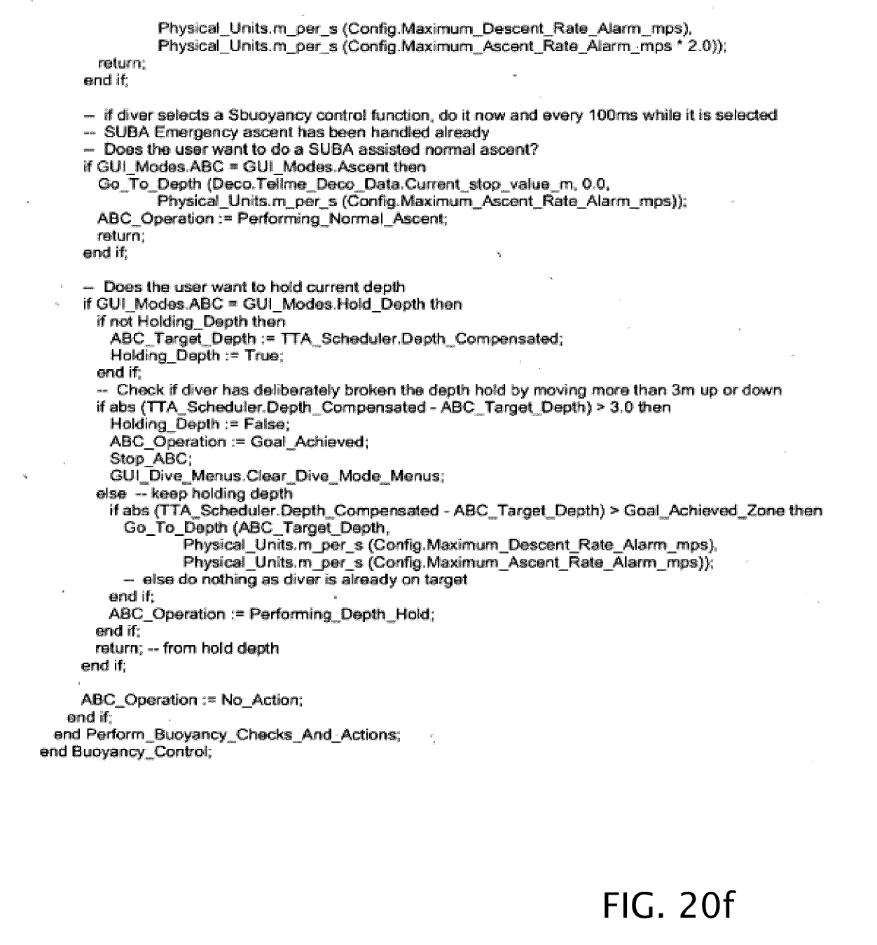

FIG. 9 shows an alternative example of SUBA as constructed.

### Safe Automatic Buoyancy Control Device

FIG. 10 shows an example of the overall configuration of the present invention onto a BCD bladder (1), having each of the following essential parts of the overall system for automatic buoyancy control:

1. A means to connect to a pressurized gas supply (3).

2. A hose (7) carrying the pressurized gas supply to a plurality of electrically operated gas valves.

3. An electrically operated gas valve that is able to pressurize a gas hose that powers a means to produce a mechanical motion within a vent valve, and also a second electrically operated gas valve able to apply gas to inflate the bladder.

4. At least one or more vent valves per bladder, each being pneumatically activated.

5. A controller which contains sensors to measure pressure and either circuitry or sensors to measure the first and second derivatives of pressure, run a control code using those parameters and produce signals to open or close at least two electrically operated gas valves.

6. Housings and interconnect required to connect and protect the above subsystems.

Examples may optionally include a diver display, dive computer and user controls.

An example of a novel means to take a gas supply is show in detail in cross-section diagrams forming FIG. 10 and FIG. 14, and shown externally in FIGS. 11 to 13, comprising a means to connect to a pressurized gas supply (3) in this case by use of a novel gas supply fitting detailed in FIG. 16, that attaches to a conventional manual inflator (5) to provide a gas supply to a fine bore hose (7) but which allows the inflator to be disabled by disconnecting the incoming gas supply using a conventional SCUBA inflator nipple (9) and connector (11).

The gas supply device in the example of the invention comprises just three main parts, shown in section in FIG. 16: a barrel (13) that extends the hose from the manual inflator to the bladder, a second barrel (15) that extends the standard BCD gas nipple (9), and a shell (17) that holds these two elements in place and provides a connector fitting (19) into which plugs a gas hose (7) that provides a gas feed to the actuators.

The important feature of the preferred and novel gas supply fitting (3) taking a gas feed from the manual inflator shown in FIG. 16 is that in the event of an unwanted increase in buoyancy the diver need only disconnect the connection from the gas cylinder to the BCD, just has the diver would with a manual BCD, and vent manually. The vent valves (2) in the preferred example have a conventional manual pull dump (33) in addition to the gas powered piston (27). Moreover the manual inflator has a pull-cord (8) in the examples connecting to a vent valve in the actuator block (42). There is no need for the diver to perform any diagnostics to determine whether the manual inflator has failed open, or the automatic system: the diver simply needs to disconnect the gas supply. The present invention also allows the diver to vent gas using manual pull-dumps: in the preferred examples these are integral to the vent valves of the present invention. The gas feed to the actuator valves is flow limited such as by use of a small bore hose (7) or orifices such that the vents can always dump gas at a greater rate than it can be injected.

A hose (7) carries the gas from the inflator to the actuators is preferably is a narrow bore hose. Kynar hoses are available with a 0.8 mm bore and an outer diameter of 3.6 mm, which have the effect of limiting the maximum flow rate when used with typical BCD gas supply pressures to around 20 liters of gas flow per minute, and have a burst pressure exceeding the gas supply cylinder high pressure, such that if the first stage cylinder pressure regulator were to fail, then the hose (7) would not rupture, and therefore there is no risk of the bladder in the BCD being inflated suddenly. Moreover, use of a very small bore hose means that should the hose break, the flow rate into the bladder is much lower than the minimum vent rate if the diver uses the manual vent controls on the vent valves.

An example of an actuator means according to the present invention is shown in cross-section in FIGS. 11 to 14, whereby a plurality of gas valves (20) and (21) are arranged such that when activated route the gas from the hose (7) is routed to either the bladder volume (23) or to a second hose (25) that actuates all the vent valves simultaneously. In the preferred example a novel arrangement of valves are used, whereby the first valve is a normally closed 2 way valve and the second valve is a three way valve. A 2-way normally closed valve simply opens the gas supply route between two ports, A and B, when energized by sufficient electrical power. A 3-way valve has two states and three ports, A, B and C: when not energized then Port A is connected to Port B, but not to Port C. When energized, the Port A is connected to Port C but not to Port B. In the example these ports are arranged as shown in FIG. 15. A first valve (20) is a 2-way normally closed valve which when actuated injects gas into the bladder via an outlet (28) with a gas pathway to the bladder, and a second valve is a 3-way valve (21) which pressurizes a second hose (25) when the valve (21) is activated, and pressure in that hose (25) powers gas pistons (27) that open the vent valves (2), such as those shown in FIG. 17 or combined with the actuator block (42) as shown in FIGS. 11 to 14. When the 3-way valve is not activated it drains the gas hose (25) to the vent valves (2) into the bladder: a very small gas volume is vented as the preferred example uses fine bore hoses (7) and (25). Gas paths within a manifold (22) are used to implement the main gas paths in this example, along with internal gas hose (26) and gas connectors (19).

The supply hose (7) to the gas valves (20) and (21) is preferably flow limited by its bore, and the vent valves (2) such as shown in FIG. 14 incorporate springs (37) and optionally (38) that close the valve when it is not powered. It is possible but not preferable to add a further flow restriction by use of an orifice or choice of small bores within the connectors (24) to the gas hose (7) or gas routing manifold (22).

An alternative using two 2-way electrically operated gas valves in series instead of the arrangement in FIG. 15, such that opening the first 2-way, gas valve pressurizes the hose (25) to the vent valves and the second 2-way gas valve vents that hose to the bladder, has less desirable safety characteristics than the preferred combination described herein. In the case where to 2-way valves are used in series, to add gas to the bladder both gas valves would be opened simultaneously, and to vent the bladder the first solenoid valve would be opened and the second closed. The reason this is not the preferred example is that if electrical power were to fail while the vent valves were active, then pressure would be trapped in the second hose (25) that would keep the valves open. In this case, the diver would lose all buoyancy, which is not a fail-safe condition. This non-preferred arrangement of 2-way gas valves also uses twice as much electrical power to inject gas into the bladder as the novel and preferred arrangement shown in FIG. 15, and described in FIGS. 11 to 14. Use of two 2-way valves in parallel is not an option because energizing the valve to pressurize the hose (25) to the vents (2) would not have means to relieve the pressure so the vents would operate continuously, and hence not function correctly.

In some examples it may be desirable to have a pull-cord or lever (4) on the manual inflator (5) such as that illustrated in FIG. 10, to shut off the gas supply to the gas valves only, but leave the gas supply to the manual injector connected. The diver would still be able to disable both means to add gas to the bladder by disconnecting the incoming gas hose at the connector (9) and (11) on the manual inflator.

Vent valves (2) with the features shown in FIG. 17 namely an input gas hose (25), pressure in which causes a piston (27) to move and open a plug or stopper (29), allowing gas in the bladder to escape through a one-way valve (31). A manual pull-dump (33) is preserved in the preferred example, allowing manual operation of the vent by the diver at any time. The pull-dump cords (35) may be singular or may be combined: a minimum of three of the vent valves (2) must be fitted to the bladder in positions such that there is an open gas path between the retained gas in the bladder and at least one vent valve when the bladder is immersed in water. A novel feature of the vent valves in the preferred example is the use of a wave spring (37) to apply even pressure to the plug (29) such that seats evenly. Retainers (39) prevent the spring (37) from being displaced laterally. The use of the wave spring avoids the valve leaking if it is operated manually with a motion that in a conventional vent valve would tend to cause the plug (29) to take up an angle instead of remaining level with respect to the valve seat (30). A key feature of the vent valve is that the plug (29) is not firmly attached to the piston (27), such that pulling the plug (29) via the cord (35) causes the plug (29) to lift off the seat (31) without the piston (27) having to move.

A wave spring is a type of compression spring built from a series of thin washers that have a wave-like profile. Compressing the washers, which are normally welded together, results in a reactive force that is even around the circumference of the spring. A wave spring can also provide a greater extension for a particular spring force and spring bound size than a conventional wire compression spring, which can be advantageous in this application.

The controller for the electrically powered gas valves (20), (21) in the present invention uses sensor signals from the pressure first differential of the pressure (i.e. speed), and the second differential of the pressure (acceleration). In order to obtain a figure for acceleration that is sufficiently accurate for control purposes, a resolution would be required from a depth sensor that is not available using current technology: mathematical, modelling reveals that at least 28 bits of accuracy is required if the pressure sensor signal were to be digitized and the acceleration calculated using a digital means. To overcome this, the present invention uses an analogue circuit shown in block form in

FIG. 19 to obtain these differentials, directly from the sensor data.

The values for signal levels shown in FIG. 19 are indicative only, to describe why a discrete circuit is used or separate sensors to obtain the speed and acceleration data instead of digital means using the ambient pressure data.

It is not feasible to obtain dive acceleration data from a digital process that has the digitized ambient pressure sensor signal as input due to the magnitude of the signals involved. A 0 to 1V pressure sensor measuring 0 to 10 bar (0 to 100 m of fresh water), would give a signal of diver speed at a 10 m/min ascent rate of just 1.67 mV, and the diver's acceleration is more than an order of magnitude lower still. The critical control acceleration data would be two orders of magnitude lower, and typically at least 8 bits of acceleration data are needed using the control process described herein. These requirements combine to create the need for a 28 to 30 bit ADC: such a device does not exist in a form suitable for integration with dive electronics.

To provide the acceleration data, the present invention uses either a 3-axis accelerometer or a novel arrangement shown in block form in FIG. 19 whereby through the use of two analogue differentiators, which have a gain greater than unity, the acceleration signal can be extracted from the ambient pressure signal and presented to an ADC of an accuracy that is readily available. This latter approach has sufficient magnitude and accuracy to enable the overall control system to operate in a stable manner when each of the two analogue differentiator stages have a gain of 300. The combined gain of 90,000 raises the acceleration differential into the range that a 16 to 18 bit ADC, such as a low cost Sigma-Delta ADC. Other gain values can be used and should be matched in any case to the voltage range of the pressure sensor, and ADC input voltage range. The amplification uses preferably either chopper type operational amplifiers or amplifiers of equivalent performance as the signals are close to DC in frequency.

The present invention provides the means to offer the diver facilities such as:
1. Control the descent rate or impose a maximum descent rate.
2. Control the ascent rate or impose a maximum ascent rate. A plurality of ascent rates may be supported, for emergency, controlled and normal ascents.
3 Follow a depth profile or profiles automatically.
4. By integration with a processing unit, for example, with a dive computer (40), it may provide the ability to follow a decompression profile automatically.
5. By integration with a dive cylinder pressure sensing device, it may set a minimum cylinder pressure, below which the device may initiate an ascent sequence automatically.

The recommended safety ascent rate in decompression diving is almost universally 10 m/min, and the maximum of 18 m/min to 20 m/min depending on the training agency involved. The maximum ascent rate achievable for a diver identified from accident studies is 110 m/min: this is generally not survivable if the diver has any significant gas loading in his tissues.

The diver's respiration causes a natural oscillation in the diver's buoyancy that is preferably removed from the input pressure, speed and acceleration data. This can be achieved using a Kalman (digital) filter. Respiration has a center frequency of 0.3 Hz, and a low pass filter of 0.1 Hz is sufficient, bounded by a vertical depth change (e.g. a 0.5 m window the diver should be in). There is no predictive element required to the filter that removes respiratory effects: it may be a conventional FIR (Finite Impulse Response Filter), such as a fifth order Chebyshev Low Pass filter. It is advantageous to combine parts of the filter with the differentiator, such as shown for the first differentiator in the example in FIG. 19.

For a better understanding of the control process, the example given by the Ada code in FIG. 17 some of the calculations used in the code will be described.

The smallest imbalance of the forces applied to the body in the water provides motion, either towards the surface or towards the sea bottom. The direction depends on the imbalance sign.

The relation between the depth and the imbalance forces has positive feedback within a buoyancy compensator: as the depth increases, the volume of gas in the bladder reduces with Boyles Law so the acceleration increases, and vice versa for ascent. The positive feedback is greatest near the surface: the volume changes as a fraction of the change in depth relative to surface pressure.

In a buoyancy control system, the acceleration itself is the integral of the injected and drained gas flows, adjusted for temperature and ambient pressure, which change the displacement of the diver's buoyancy bladder along with the SCUBA equipment. It is not possible to measure these parameters directly, so the acceleration that the other parameters combine to produce is measured and the buoyancy is determined from that acceleration data. The acceleration is limited by the maximum buoyancy (positive and negative).

The diver's acceleration is proportional to the imbalance of the force applied to the body. The increment in the buoyancy force is proportional to the increment of the bladder volume. Changes in the bladder volume are proportional to temperature of the gas it encloses, and the change to the gas volume from injecting or venting gas and the change in volume of the enclosed gas (which is inversely proportional to the depth). To simplify the presentation of this, the controlled buoyancy is considered as the integral of injected/drain gas flow rate and average depth.

The path of the dive is considered as a series of waypoints, or “way” in the example code. The magnitude of a waypoint is a displacement from the start position. Reference to “position” refers to an ambient pressure value or a depth: the lateral position of the diver is unknown and not relevant.

In addition to values derived from sensors, the control algorithm makes use of external parameters. Typical values for these in an example are:
ABC_Sample_Time_s=0.01;
Ambient_Pressure_Sea_Level_bar=1.0;
Salinity=1020;—gms per liter if accurate depth in meters is required Diver_Weight_kg=120.0;
Exhaust_Atm_Rate_lps=−1.5;
Injector_Atm_Rate_lps=1.1;
Speed_Descent_max_mps=0.5; [
Speed_Ascent_max_mps=−0.33333;
Accel_Descent_max_mpss=0.035;
Accel_Ascent_max_mpss=−0.035;
BC_Inj_Rate_Atmlps=1.1;
BC_Drain_Rate_Atmlps=−1.5;
Ambient_Pressure_Sea_Level_bar=1.013;—One atm is 1.013 bar.

Variations of/these variables are not critical, but errors can make the control loop take longer achieve the desired depth. Significant errors in declaring these parameters can cause a low magnitude damped overshoot using the process algorithm given. Some parameters such as the diver's weight can tolerate large errors, as the drag on the diver depends not just on weight by also on the diver's attitude in the water and body position.

When the initial acceleration and speed is zero the control process calculates the control time for when the acceleration/deceleration must be switched on/off as follows:

1. If

$$w \leq \frac{{V}_{max}^{2}}{α}$$

(Vₘₐₓ is maximum speed, α is acceleration),
the time when the acceleration changes its sign is

$${r}_{1} = \sqrt{\frac{w}{α}} .$$

The time 2t₁ is the time when the deceleration force must be switched off. This ideal system reaches the set position with zero speed and acceleration for the minimum time. Gas consumption depends on the speed limit.

If

$$w > \frac{{V}_{max}^{2}}{α} ,$$

then the time when the body moving with acceleration is

$${t}_{1} = \frac{{V}_{max}}{α}$$

and the time when the motion has the maximum speed is

$$t 2 = \frac{w}{{V}_{max}} - \frac{{V}_{max}}{α} .$$

The deceleration time equals t₁.

The buoyancy bladder volume which decreased during descent and increased during ascent must be restored by the end of the control period in order for the diver to regain their steady state. The difference between the injected and the drain gas is proportional to the change in water pressure, which is a ratio of the start depth to the end depth, i.e. the depths at the beginning and end of the set of waypoints, as well as temperature. Using the set depth function in the example code, the injection and drain rates, the current acceleration, speed and start depth, the buoyancy control calculates the time intervals in which the injection/drain is on or off to compensate for the depth and temperature change.

The limiting effect of water on the body is calculated using the following relationships:

Force applied to the body F_{b}=Fₐ−F_{g}−Fᵣ,

Where: Fₐ is buoyancy force; F_{g} is gravity force; Fᵣ is resistance force Resistance force Fᵣ=C×S×ρ=V²/2

Where C is shape factor; S is cross-sectional area of the body; p is fluid density; V is velocity of the body. This formula is valid in a limited range of sizes and velocities of bodies in water: from about 10 cm to 10 m and 1 cm/s to 10 m/s. The most difficult part of this formula is to determine the shape factor C. For two bodies of different size, weight, material, but the same shape, this coefficient C is the same. For example, for a sphere C=0.4, for a body drop-shaped and oblong ellipsoid C=0.05 to 0.1. The smaller the bubbles, then the smaller their rate of ascent. Typically, this rate is 0.3 to 0.5 m/sec depending on the bubble size. This is 18 m to 30 m per minute. The average density of the human body 1070 kg/m3 but the weighting and environmental protection of a diver as well as the equipment carried can cause this to vary significantly when the diver is considered as a whole is. As a consequence, calculation cannot provide a reliable shape factor, therefore it was determined experimentally. The known maximum ascent rates are achieved by divers who take a head-up profile, and achieved a 110 m/min rate would suggest a shape factor that is 3 to 4 times more efficient than a bubble. The control code given is stable over this 4 to 1 range of Reynolds coefficients (shape factors, C).

There are two modes for the buoyancy control:
maximum speed control mode when the magnitude of the waypoints to the set depth are above the magnitude of the waypoints for deceleration from the maximum speed,
set position mode when the waypoints to the set depth are less than the waypoints for deceleration from the maximum speed.

Control may start with nonzero initial speed or/and acceleration.

In Maximum speed control mode, the time to deceleration from the maximum speed is:

$$t\_d = \frac{α\_c}{F\_d} ,$$

where a_c is current acceleration; F_d is the buoyancy size increment rate. Differences between the maximum speed where the acceleration is zero and the current speed are:

$$V\_d = \frac{α\_c}{2} \times t\_d , or V\_d = \frac{{α\_c}^{2}}{2 F\_d}$$

In this mode, the waypoint displacement to the set depth is more than the waypoint displacement for deceleration from the maximum speed, the control calculates the current acceleration, speed and V_d. If the differences between the maximum and current speed is more than V_d the control injects gas into the buoyancy bladder. At the moment when the system reaches the V_d point the control closes the injection valve and starts to drain gas from the bladder, until the acceleration drops to zero.

The error of the maximum speed control depends on the F_d accuracy and the water resistance. Feedback in the buoyancy control can increase the accuracy of the motion.

In the second main control mode, Set Position Mode, to minimize sensitivity to external and feedback factors the control in the ‘set position goal mode’ routine includes three phases:

1. reduction of the speed to the minimum value,

2. motion under constant speed until the deceleration area is reached,

3. reduction of the speed to zero in the deceleration area.

The following equations may be used in the control process. Note that the t1 interval includes drain (t1_d) and injection (t1_i).

$$t 1 \_d = \sqrt{\frac{2 \times dV}{( F\_d + \frac{{F\_d}^{2}}{F\_i} ) / weight} ,}$$

$$t 1 \_i = \sqrt{\frac{2 \times dV}{( F\_i + \frac{{F\_i}^{2}}{F\_d} ) / weight}}$$

where dV is required speed reduction; F_d is drain flow rate; F_i is injected flow rate; weight is the sum of the total diver and SCUBA equipment weight.

The same equations are used to calculate the time of the gas switching events in the t3 interval.

The following further equations are derived:

$$t 1 \_i = \sqrt{\frac{2 \times dV}{( F\_i + \frac{{F\_i}^{2}}{F\_d} ) / weight} ,}$$

$$t 1 \_d = \sqrt{\frac{2 \times dV}{( F\_d + \frac{{F\_d}^{2}}{F\_i} ) / weight}}$$

where dV is required speed reduction (between constant speeds when acceleration is zero); F_d is drain flow rate; F_i is injected flow rate; weight is total diver and SCUBA equipment weight.

And:

$$t 3 \_d , t 5 \_d = \sqrt{\frac{2 \times dV}{( F\_d + \frac{{F\_d}^{2}}{F\_i} ) / weight} ,}$$

$$t 3 \_i , t 5 \_i = \sqrt{\frac{2 \times dV}{( F\_i + \frac{{F\_i}^{2}}{F\_d} ) / weight}}$$

From these, the characteristics of the position control can be determined when the initial speed and acceleration are positive.

If the start acceleration and velocity is not zero, the t1 interval including drain (t0, t1_d) and injection (t1_i) is calculated as following:

$$t 0 = \frac{α\_ini}{F\_d} ,$$

where a_ini is initial acceleration.

$$t 1 \_d = \sqrt{\frac{2 \times ( d V + a\_ini * t 0 / 2 )}{( F\_d + \frac{{F\_d}^{2}}{F\_i} ) / weight}} + t 0 , \\ t 1 \_i = \sqrt{\frac{2 \times ( d V + a\_ini * t 0 / 2 )}{( F\_i + \frac{{F\_i}^{2}}{F\_d} ) / weight}}$$

where dV is required speed reduction; F_d is drain flow rate; F_i is injected flow rate; weight is total diver and SCUBA equipment weight.

$${way}_{t 0} = {V}_{ini} t 0 + {α}_{ini} \frac{t {0}^{2}}{6} , {way}_{t 1} = {V}_{ini} t 0 + {α}_{ini} \frac{t {0}^{3}}{6}$$

The same equations apply when the initial acceleration is negative.

The next set of equations add in the effect of changes in the water pressure (i.e. depth) and resistance in moving through the water column

The control process manages the distinct phases of diver's movement.

### First Phase, Phase A: Force Equalization

The control is complicated by the situation when the minimum buoyancy bladder size increment is less than it needs to be for the buoyancy control. It occurs when the initial acceleration is more than the maximum acceleration which the buoyancy bladder could generate.

Second Phase, Part B: Achieve the Desired Speed with Non Zero Start Acceleration

The first and second “a” phases could be replaced by the following control (which is a function that depends on the distance to the set position):

hold the initial acceleration until the speed drops to the corresponding value then decrease the acceleration to zero;

increase the acceleration until its maximum value then wait until the speed drops to the corresponding value then decrease the acceleration to zero.

### Third Phase: Constant Speed Motion

During this phase the acceleration is zero: the system calculates phase duration time to pass through the waypoints with constant speed.

Fourth Phase: Motion with Limited Acceleration

The bladder capacity limits the maximum buoyant acceleration.

The deceleration profile from the initial speed to zero depends on the initial deceleration and speed. There are four main types of profile (mode of motion). Each profile has its own characteristic waypoints.

In addition to the two obvious modes of approaching the waypoint linearly, there is a third mode where if the profile waypoint is less than the waypoint to the set position the control process increases acceleration and speed towards their maximum values and at each time clock step calculates the deceleration waypoint with new initial parameters. In the case when the deceleration profile is more than the waypoint to the set position or profile, the control generates motion in the reverse direction the device decelerates until the diver stops (acceleration and speed are zero) and only then provides motion to the set position.

For this section the following notations are adopted:
ds—increment of waypoint;
v_ini—initial speed;
v_max—maximum speed;
aini—initial acceleration;
a_max—initial maximum acceleration;
t—time;
fb—rate of buoyancy force increment (depends on gas injection/drain, water pressure and total weight).

Each of the four modes I to IV will now be considered in turn, taken from the graph in FIG. 18, and also three other cases V to VII to provide exhaustive coverage. The following equations apply in Mode I:

$${t}_{3} = \frac{α\_max}{fb\_inj} , \\ {ds}_{3} = - \frac{{α\_max}^{3}}{6 * {fb\_inj}^{2}}$$

$$d {α}_{1} = α\_max - α\_ini , \\ {t}_{1} = - \frac{{da}_{1}}{fb\_drain} , \\ {dv}_{1} = \frac{α\_max + α\_ini}{2} {t}_{1} , \\ {dv}_{2} = - ( v\_ini + {dv}_{1} + \frac{α\_max}{2} {t}_{3} )$$

$${t}_{2} = \frac{{dv}_{2}}{α\_max} , \\ {ds}_{2} = ( v\_ini + {dv}_{1} + \frac{{dv}_{2}}{2} ) {t}_{2} , \\ s\_mode ( 1 ) = {ds}_{1} + {ds}_{2} + {ds}_{3}$$

The following equations apply in Mode II:

$$α\_p = \sqrt{\frac{2 * v\_ini * fb\_drain * fb\_inj + {α\_ini}^{2} * fb\_inj}{fb\_inj - fb\_drain}}$$

$$d {α}_{1} = α\_p - α\_ini$$

$${t}_{1} = - \frac{{da}_{1}}{fb\_drain}$$

$${dv}_{1} = \frac{α\_p + α\_ini}{2} {t}_{1} , \\ {ds}_{1} = v\_ini * {t}_{1} + ( \frac{a\_ini}{2} + \frac{{da}_{1}}{6} ) {t}_{1}^{2} , \\ {t}_{2} = \frac{α\_p}{fb\_inj}$$

$${dv}_{2} = \frac{α\_p}{2} {t}_{2} , \\ ds 2 = ( v\_ini + {dv}_{1} ) t 2 + \frac{α\_p}{3} t {2}^{2} , \\ s\_mode ( 2 ) = {ds}_{1} + {ds}_{2}$$

The following equations apply in Mode III:

$${t}_{1} = \frac{a\_ini}{fb\_inj}$$

$${dv}_{1} = \frac{α\_ini}{2} {t}_{1} , \\ {a\_v}_{0} = \sqrt{{a\_ini}^{2} + 2 * v\_ini * fb\_inj}$$

$${t}_{01} = \frac{a\_ini - a\_v 0}{fb\_inj}$$

$${ds}_{01} = v\_ini * {t}_{01} + \frac{a\_ini}{2} {t}_{01}^{2} - \frac{a\_ini - a\_v 0}{6} {t}_{01}^{2} , \\ {t}_{02} = {t}_{1} - {t}_{01}$$

$${ds}_{02} = \frac{a\_v 0}{3} {t}_{02}^{2}$$

$${ds}_{1} = {ds}_{01} + {ds}_{02}$$

$${t}_{2} = \sqrt{\frac{2 * ( v\_ini + {dv}_{1} )}{fb\_inj - \frac{{fb\_inj}^{2}}{fb\_drain}}}$$

$${da}_{2} = - fb\_inj * {t}_{2}$$

$${dv}_{2} = \frac{{da}_{2}}{2} {t}_{2}$$

$${ds}_{2} = ( v\_ini + {dv}_{1} ) {t}_{2} + \frac{d {α}_{2}}{6} {t}_{2}^{2}$$

$${t}_{3} = \sqrt{\frac{2 * v\_ini + {dv}_{1}}{- fb\_drain + \frac{{fb\_drain}^{2}}{fb\_inj}}}$$

$${da}_{3} = - {da}_{2}$$

$${dv}_{3} = - \frac{d {α}_{3}}{2} {t}_{3}$$

$${ds}_{3} = \frac{d {α}_{3}}{3} {t}_{3}^{2}$$

$$s\_mode ( 3 ) = {ds}_{1} + {ds}_{2} + {ds}_{3}$$

Mode IV covers the case where there is the motion with and without any acceleration limit.

The following equations apply in Mode IV when acceleration is less than the maximum:

$${t}_{1} = \sqrt{\frac{2 * v\_ini}{fb\_drain - \frac{{fb\_drain}^{2}}{fb\_inj}}}$$

$${da}_{1} = - fb\_drain * {t}_{1}$$

$${dv}_{1} = \frac{d {α}_{1}}{2} {t}_{1}$$

$${ds}_{1} = v\_ini * {t}_{01} + \frac{{da}_{1}}{6} {t}_{1}^{2}$$

$${da}_{2} = - {da}_{1}$$

$${t}_{2} = - \frac{{da}_{2}}{fb\_inj}$$

$${dv}_{2} = - \frac{d {α}_{2}}{2} {t}_{2}$$

$${ds}_{2} = \frac{{da}_{2}}{6} {t}_{2}^{2}$$

$$s\_mode ( 4 ) = {ds}_{1} + {ds}_{2}$$

The following further equations apply in Mode IV for the limited acceleration condition:

$${t}_{3} = \frac{a\_max}{fb\_inj}$$

$${dv}_{3} = \frac{α\_max}{2} {t}_{3}$$

$${ds}_{3} = - \frac{a\_max}{6} {t}_{3}^{2}$$

$${t}_{1} = - \frac{a\_max}{fb\_drain}$$

$${dv}_{1} = \frac{α\_max}{2} {t}_{1}$$

$${ds}_{1} = v\_ini * {t}_{1} + \frac{a\_max}{6} {t}_{1}^{2}$$

$${dv}_{2} = - ( v\_ini + {dv}_{1} + {dv}_{3} )$$

$${t}_{2} = \frac{{dv}_{2}}{a\_max}$$

$${ds}_{2} = ( v\_ini + {dv}_{1} + \frac{{dv}_{2}}{2} ) {t}_{2}$$

$$s\_mode ( 4 ) = {ds}_{1} + {ds}_{2} + {ds}_{3}$$

The following equations apply in Mode IV when the initial acceleration is zero but speed is positive:

$${t}_{1} = \sqrt{\frac{2 * v\_ini}{fb\_inj - \frac{{fb\_inj}^{2}}{fb\_drain}}}$$

$${da}_{1} = - fb\_inj * {t}_{1}$$

$${dv}_{1} = \frac{d {α}_{1}}{2} {t}_{1}$$

$${ds}_{1} = v\_ini * {t}_{01} + \frac{{da}_{1}}{6} {t}_{1}^{2}$$

$${da}_{2} = - {da}_{1}$$

$${t}_{2} = - \frac{{da}_{2}}{fb\_drain}$$

$${dv}_{2} = - \frac{{da}_{2}}{2} {t}_{2}$$

$${ds}_{2} = \frac{{da}_{2}}{6} {t}_{2}^{2}$$

$$s\_mode ( 4 ) = {ds}_{1} + {ds}_{2}$$

The following equations apply in Mode IV when the initial acceleration is zero but speed is positive, and acceleration is limited (e.g. the bladder is empty or full):

$${t}_{3} = \frac{a\_max \_bck}{fb\_drain}$$

$${dv}_{3} = \frac{α\_max \_bck}{2} {t}_{3}$$

$${ds}_{3} = \frac{a\_max \_bck}{6} {t}_{3}^{2}$$

$${t}_{1} = - \frac{a\_max \_bck}{fb\_inj}$$

$${dv}_{1} = \frac{α\_max \_bck}{2} {t}_{1}$$

$${ds}_{1} = v\_ini * {t}_{1} + \frac{a\_max}{6} {t}_{1}^{2}$$

$${dv}_{2} = - ( v\_ini + {dv}_{1} + {dv}_{3} )$$

$${t}_{2} = \frac{{dv}_{2}}{a\_max \_bck}$$

$${ds}_{2} = ( v\_ini + {dv}_{1} + \frac{{dv}_{2}}{2} ) {t}_{2}$$

$$s\_mode ( 4 ) = {ds}_{1} + {ds}_{2} + {ds}_{3}$$

A fifth mode, Mode V, is where motion has a negative initial speed and negative acceleration. The following equations apply in this mode under the twin negative conditions:

$${t}_{1} = \frac{a\_ini}{fb\_drain}$$

$${dv}_{1} = \frac{α\_ini}{2} {t}_{1}$$

$${ds}_{1} = v\_ini * {t}_{1} + \frac{a\_ini}{3} {t}_{1}^{2}$$

$${t}_{2} = \sqrt{\frac{2 * ( v\_ini + {dv}_{1} )}{fb\_drain - \frac{{fb\_drain}^{2}}{fb\_inj}}}$$

$${da}_{2} = - fb\_drain * {t}_{2}$$

$${dv}_{2} = \frac{d {α}_{2}}{2} {t}_{2}$$

$${ds}_{2} = ( v\_ini + {dv}_{1} ) * {t}_{2} + \frac{{da}_{2}}{6} {t}_{2}^{2}$$

$$s\_mode ( 5 ) = {ds}_{1} + {ds}_{2}$$

The following equations apply in this mode under the twin negative conditions when there is a limit to the deceleration:

$${t}_{1} = \frac{a\_ini}{fb\_drain}$$

$${dv}_{1} = \frac{α\_ini}{2} {t}_{1}$$

$${ds}_{1} = v\_ini * {t}_{1} + \frac{a\_ini}{3} {t}_{1}^{2}$$

$${t}_{2} = \sqrt{\frac{2 * ( v\_ini + {dv}_{1} )}{fb\_drain - \frac{{fb\_drain}^{2}}{fb\_inj}}}$$

$${da}_{2} = fb\_drain * {t}_{2}$$

$${t}_{4} = \frac{a\_max \_frw}{fb\_inj}$$

$${dv}_{4} = \frac{α\_max \_frw}{2} {t}_{4}$$

$${ds}_{4} = \frac{a\_max \_frw}{6} {t}_{4}^{2}$$

$${t}_{2} = - \frac{a\_max \_frw}{fb\_drain}$$

$${dv}_{2} = \frac{α\_max \_frw}{2} {t}_{2}$$

$${ds}_{2} = ( v\_ini + {dv}_{1} ) * {t}_{2} + \frac{a\_max \_frw}{6} {t}_{2}^{2}$$

$${dv}_{3} = - ( v\_ini + {dv}_{1} + {dv}_{2} + {dv}_{4} )$$

$${t}_{3} = \frac{{dv}_{3}}{a\_max \_frw}$$

$${ds}_{3} = ( v\_ini + {dv}_{1} + {dv}_{2} + \frac{{dv}_{3}}{2} ) {t}_{3}^{2}$$

$$s\_mode ( 5 ) = {ds}_{1} + {ds}_{2} + {ds}_{3} + {ds}_{4}$$

Mode VI is where there is positive initial speed, but negative initial acceleration. The following equations apply in this mode:

$${t}_{3} = \frac{α\_max \_bck}{fb\_drain} , \\ {dv}_{3} = \frac{α\_max \_bck}{2} {t}_{2}$$

$${ds}_{3} = - {dv}_{3} * {t}_{3} + \frac{α\_max \_bck}{2} {t}_{3}^{2}$$

$$d {α}_{1} = α\_max - α\_ini , \\ {t}_{1} = - \frac{{da}_{1}}{fb\_inj}$$

$${dv}_{1} = \frac{α\_max \_bck + α\_ini}{2} {t}_{1}$$

$${dv}_{2} = - ( v\_ini + {dv}_{1} + {dv}_{3} )$$

$${t}_{2} = \frac{{dv}_{2}}{α\_max \_bck} , \\ {ds}_{2} = ( v\_ini + {dv}_{1} + \frac{{dv}_{2}}{2} ) {t}_{2} , \\ s\_mode ( 6 ) = {ds}_{1} + {ds}_{2} + {ds}_{3}$$

Under the boundary condition where the time between the change in acceleration is zero, the following equations apply:

$$α\_p = - \sqrt{\frac{2 * v\_ini * fb\_drain * fb\_inj + {α\_ini}^{2} * fb\_drain}{fb\_drain - fb\_inj}}$$

$$d {α}_{1} = α\_p - α\_ini$$

$$t 1 = - \frac{da 1}{fb\_inj}$$

$${dv}_{1} = \frac{α\_p + α\_ini}{2} {t}_{1} , \\ {ds}_{1} = v\_ini * {t}_{1} + ( \frac{a\_ini}{2} + \frac{{da}_{1}}{6} ) {t}_{1}^{2} , \\ {t}_{2} = \frac{α\_p}{fb\_drain}$$

$${dv}_{2} = \frac{α\_p}{2} {t}_{2} , \\ ds 2 = ( v\_ini + {dv}_{1} ) {t}_{2} + \frac{α\_p}{3} t {2}^{2} , \\ s\_mode ( 6 ) = {ds}_{1} + {ds}_{2}$$

The converse condition of positive speed and negative acceleration is described by:

$${t}_{1} = - \frac{a\_ini}{fb\_drain}$$

$${dv}_{1} = \frac{α\_ini}{2} {t}_{1} , \\ {a\_v}_{0} = \sqrt{{a\_ini}^{2} + 2 * v\_ini * fb\_inj}$$

$${t}_{01} = \frac{a\_ini + a\_v 0}{fb\_drain}$$

$${ds}_{01} = v\_ini * {t}_{01} + \frac{a\_ini}{2} {t}_{01}^{2} - \frac{a\_ini * a\_v 0}{6} {t}_{01}^{2} , \\ {t}_{02} = {t}_{1} - {t}_{01}$$

$$ds 02 = - \frac{a\_v 0}{3} t {02}^{2}$$

$${ds}_{1} = {ds}_{01} + {ds}_{02}$$

$${t}_{2} = \sqrt{\frac{2 * abs ( v\_ini + {dv}_{1} )}{- fb\_drain + \frac{{fb\_drain}^{2}}{fb\_inj}}}$$

$${da}_{2} = - fb\_drain * {t}_{2}$$

$${dv}_{2} = \frac{{da}_{2}}{2} {t}_{2}$$

$${ds}_{2} = ( v\_ini + {v}_{1} ) {t}_{2} + \frac{d {α}_{2}}{6} {t}_{2}^{2}$$

$${t}_{3} = \sqrt{\frac{2 * abs ( v\_ini + {dv}_{1} )}{fb\_inj - \frac{{fb\_inj}^{2}}{fb\_drain}}}$$

$${da}_{3} = - {da}_{2}$$

$${dv}_{3} = - \frac{{da}_{3}}{2} {t}_{3}$$

$${ds}_{3} = \frac{d {α}_{3}}{6} {t}_{3}^{2}$$

$$s\_mode ( 6 ) = {ds}_{1} + {ds}_{2} + {ds}_{3}$$

Mode VII is the case where the diver has positive initial speed and acceleration. The relevant equations are:

$${da}_{1} = - a\_ini$$

$${t}_{1} = - \frac{{da}_{1}}{fb\_inj}$$

$${dv}_{1} = \frac{α\_ini}{2} {t}_{1}$$

$${ds}_{1} = v\_ini * {t}_{1} - \frac{{da}_{1}}{3} {t}_{1}^{2}$$

$${t}_{2} = \sqrt{\frac{2 * ( v\_ini + {dv}_{1} )}{fb\_inj - \frac{{fb\_inj}^{2}}{fb\_drain}}}$$

$${da}_{2} = - fb\_inj * {t}_{2}$$

$${dv}_{2} = \frac{{da}_{2}}{2} {t}_{2}$$

$${ds}_{2} = ( v\_ini + {dv}_{1} ) {t}_{2} + \frac{d {α}_{2}}{6} {t}_{2}^{2}$$

$${t}_{2} = \sqrt{\frac{2 * ( v\_ini + {dv}_{1} )}{- fb\_drain - \frac{{fb\_drain}^{2}}{fb\_inj}}}$$

$${da}_{3} = - {da}_{2}$$

$${dv}_{3} = - \frac{{da}_{3}}{2} {t}_{3}$$

$${ds}_{3} = \frac{d {α}_{3}}{6} {t}_{3}^{2}$$

$$s\_mode ( 7 ) = {ds}_{1} + {ds}_{2} + {ds}_{3}$$

The control process described herein can be expressed as an exponential control algorithm but the additional complexity appears to provide no tangible benefits.

Calculation of the buoyancy control is based on knowledge of the injection and drain gas flow rates. These parameters can be updated in an adaptive control loop. The gas injection rate when the gas control valves (20), (21) are open depends on the nozzle or orifice size, gas factor, orifice pressure drop and ambient pressure. All these parameters are sufficiently stable and predictable for stable control.

The flow via the vents valves (2) is very sensitive to the valve opening and the difference between the buoyancy bladder pressure and the ambient pressure. The error of the drain flow rate estimation is the most critical parameter in these calculations. To minimize the effect of drain flow rate variations in the buoyancy control it is possible to design the valve with an adaptive buoyancy control with additional feedback that adjusts the drain rate using the system acceleration and deceleration. The same principle can be used in estimation of the injected gas rate. However, the cost of this would be significant, and it is likely to cause audio noise which would be unacceptable to the diver. The control process detailed herein is sufficient for stable control without this extra layer of complexity.

Adaptive filter and control parameters to smooth the control feedback signal to enable lower ADC resolutions and slower sample rates are used. These remove or reduce or compensate for variations in input date from:
Respiration
In closed loop diving systems, changes to the breathing loop volume
   i. via ADV/OPV valves used manually
   ii. a gradual increase in buoyancy due to O₂ consumption
   iii. O₂ injection in the system with active PPO₂ control
   iv. Gas mixture injection in SCR.
Diver rotation
Diver motion which generate forces up or down the water column.

The coding of the system can be simplified greatly, as shown in FIGS. 20a-20f, by using a pulse width modulator with an expert system, i.e., A system that combines a set of conditions based on the likely actions of an expert diver, with actions when those conditions are met. Such an expert system can reduce the dependence of the buoyancy controller on environmental parameters.

The user interface to the automatic buoyancy system may incorporate all the features of a dive computer

The dive computer can generate a dive profile, which can provide a series of targets such that when the diver selects a controlled ascent, the buoyancy system will follow the decompression profile. The profile may be adjusted for factors such as the preferred ascent rates, the depth of the first or final stops, the conservatism applied to the chosen algorithm, and give prompts for gas changes at appropriate depths.

The automatic buoyancy controller will generally require extra data or menus to be added to the dive computer display. Dive computer displays tend to be cluttered already, and this is a special problem underwater because small fonts are not readable. Another problem is the number of selection points into a menu is very small underwater: a device may have a Next and Select button but does not generally have a touch screen to select any of a set of icons directly or to enter data. New differential pressure or differential capacitive touch displays may overcome this obstacle, but at the present time these touch panel technologies do not work reliably underwater: water is both conductive and applies a uniform pressure. The touch controls may be effective on the surface but disabled when the display is wet, but it is also possible to manage the larger amount of data that is generated by an automatic buoyancy compensator using a conventional two button display. The automatic buoyancy controller and associated dive computer may simplify the presentation of data and options by using a menu represented by icons controlled by a Next and Select button. A surface menu may have large numbers of icon menus, and dive mode have very few. It is preferable that the diver should be able to select the functions of the buoyancy controller with the minimum number of actions. The Next button highlights and icon, and Select button enables or toggles its function. A menu tree using submenus below particular icons is particularly advantageous in avoiding presentation of too much data.

It is possible to execute all or part of the control process on a dive computer. The process described can be executed in a 100 ms loop on modern microcontrollers such as the ARM 7 and ARM 9, or on FPGAs. In this case all the computation can be performed in a fast loop using a time triggered architecture, with the dive computer functions calculated on a much slower loop. Typically the fast loop has a 100 ms interval and the slow loop for a dive computer has a 4 second interval. During an actual ascent under control of the buoyancy controller, the dive computer decompression profile can be suspended until the stop is reached. During the decompression stop, the dive computer (40) can update the decompression profile using the actual depth profile that was used, including the gases (and any gas switches), and the factual PPO₂ in a rebreather.

Data logging can be carried out by the buoyancy controller or dive computer (40), such that the dive log can be downloaded after the dive, or series of dives.

The dive computer (40) normally has a surface mode and a dive mode. The device will normally enter the dive mode when it is pressurized or when contacts are wet preventing reconfiguration of critical parameters underwater.

Where the automatic buoyancy control system is used with a rebreather, a fast and simple means is desirable to stop an ascent, for example if the PPO₂ is falling at a faster rate than is acceptable the ascent may require to be aborted in order for the PPO₂ to be restored or for the diver to bail out.

Minimization of the position error, gas consumption and valve energy depends on the BCD structure (gas movement paths, restrictions, characteristics of the control elements and their stability, and can be optimized in the control algorithm.

The greater the required maximum ascent/descent buoyancy speed then the more gas must be spent. A well optimized automatic buoyancy control system will generally use much less gas than a novice or intermediate level diver uses performing these functions manually.

Usually decompression is performed by in a step-by-step mode involving relatively fast motion and then long waits at the set depth. Buoyancy control with exponential depth changes (without fast motion and stops) provides the minimum gas consumption for buoyancy control. In the ideal case the gas consumption equals zero.

To provide buoyancy control with the maximum response rate it is necessary (before diving) to equalize the forces applied to the body so the buoyancy bladder and the breathing loop size are preferably close to a middle position when the diver's speed and acceleration is zero. In this case the maximum result force in ascent/descent direction is half of the buoyancy bladder size. In other words, the diver should be correctly weighted, and will use more gas if the diver is not: this weight may be greater than for a diver without any active buoyancy control by several kilograms.

Buoyancy control could provide the following descent/ascent motion modes:
Step-by step mode
Constant speed motion
Motion along required depth profile
Restrictions to the maximum speed at which the diver may ascend or descend

A buoyancy control system cannot control diver attitude efficiently. Alternative means are much better at this function (i.e. use far less energy).

Calculation of acceleration/deceleration can be used to increase system safety, estimating the spent buoyancy gas.

FIGS. 20a-20f shows a simplified control process example in the Ada language for controlling the gas injection and venting of a bladder to achieve accurate control of diver depth, enabling the diver to move from a current depth to a set depth without exceeding predefined ascent or descent rates, and also able to perform emergency ascents, controlled ascents and follow a decompression profile through changes to the Maximum Allowed Depth. The example combines elements of an expert system with that of a proportional controller, on this case a pulse width modulator

The control code, providing an example of the control process in FIGS. 20A-20f provides a well damped response, such that moving from one depth to another gradually accelerates the diver to a desired ascent or descent rate, maintains that rate or speed, then slows the diver as the diver approaches the desired depth, without oscillating or over-shoot (depth excursions).

FIGS. 20a-20f shows a simplified control process example in the Ada language for controlling the gas injection and venting of a bladder to achieve accurate control of diver depth, enabling the diver to move from a current depth to a set depth without exceeding predefined ascent or descent rates, and also able to perform emergency ascents, controlled ascents and follow a decompression profile through changes to the Maximum Allowed Depth. The example combines elements of an expert system with that of a proportional controller, on this case a pulse width modulator

The control process in FIGS. 20A-20f is suitable for re-entrant use, and would require a loop time of 100 ms or less to perform adequate control. This loop time can be achieved on microcontrollers, or using FPGAs with floating point processors. The floating point requirements can be converted to fixed point arithmetic.

In some environments a dual redundant bladder may be required. The second bladder can be operated using a separate power inflator and vent valves, and may be entirely manually controlled. The redundant bladder may exist alongside the bladder that is controlled. The redundant bladder may exist alongside the bladder that is controlled automatically or even may be included in the same overall BCD cover where the BCD comprises a bladder and outer cover.

This invention is not limited to the specific examples disclosed herein which is intended to be illustrative and it covers all modifications and alternatives coming within the scope and spirit of the invention as defined in the attached claims.

1. A device for controlling a diver's buoyancy comprising:
electro-pneumatic valves for injecting gas into an inflatable bladder and venting gas from the inflatable bladder using an automatic buoyancy controller to manage the volume of gas in the bladder that counteracts the positive feedback inherent to the expansion and compression of gas as a result of depth change, by the use of valves controlled from a calculation of the diver's depth and relative buoyancy derived directly from the diver's acceleration in the water column, without any direct measurement of gas flow or volume, where the valve control uses a series of conditions and conditional actions to add gas or remove gas, supported by a pulse width modulator to control the gas injection and venting process when moving to a desired depth under automatic control.

2. A device according to claim 1 wherein at least one gas valve pressurizes or depressurizes a pneumatic hose connecting to vent valve(s) which are opened simultaneously by that pressure and when open, vent gas from the bladder.

3. A device according to claim 1 that limits the diver's maximum ascent rate.

4. A device according to claim 1 that limits the diver's maximum descent rate.

5. A device according to claim 1 that limits the diver's maximum depth.

6. A device according to claim 1 that enables the diver to hold a selected depth.

7. A device according to claim 1 that enables the diver to follow a depth profile or a decompression profile automatically.

8. A device according to claim 1 that integrates the functions of a dive computer to generate a decompression profile that the device can follow.

9. A device according to claim 1 comprising a dive cylinder pressure sensing device enabling setting of a minimum cylinder pressure, below which the device may initiate an ascent sequence automatically.

10. A device according to claim 1 whereby a single action function is provided to stop an ascent or descent.

11. A device according to claim 1 wherein the said gas valves are arranged such that a loss of electrical or gas power causes the valves to fail in a safe state in which there is neither gas injected into the bladder nor gas vented from the bladder.

12. A device according to claim 1 wherein the said gas valves are provided with a gas supply by a module that attaches to the gas connection point for a BCD power inflator, leaving the manually controlled bladder inflator/deflator functions operable.

13. A device according to claim 1 wherein the said gas valves are provided with a gas supply by module having a single point of incoming gas connection and a plurality of gas outputs enabling the said gas valves and the BCD power inflator to be disconnected easily by the diver through a single operation.

14. A device according to claim 1 wherein the said gas valves include an electro-pneumatic 3-way solenoid valve such that the gas supply to the vent valves is opened to the ambient pressure when the 3-way solenoid valve is not energized.

15. A device according to claim 1 controlled by a process or algorithm having distinct control modes that are selected as a function of the diver's speed and acceleration.

16. A device according to claim 1 where the derivative of a diver's acceleration is used as a control parameter that is the third derivative.

17. A device according to claim 1 that combines a diver's acceleration signal with a signal proportional to the diver's speed.

18. A device according to claim 1 wherein the electro-pneumatic valves form an actuation means such that only one electro-pneumatic valve needs to be active at any one time to elucidate the desired action in the bladder, with slave valves being pneumatically operated to vent the bladder.

19. A device according to claim 1 comprising a safety means to shut down the automatic buoyancy controller without affecting the ability of the diver to perform buoyancy control manually.

20. A device according to claim 1 comprising a display and buttons to enable different functions to be configured on the surface or selected underwater by the diver.

21. A device according to claim 1 that integrates a dive computer function to generate a dive decompression profile that can be adopted by the automatic buoyancy controller.

22. A device according to claim 1 wherein menu functions are represented as icons that are selected by a Next and a Select button to enable the function represented by the icon to be configured or enabled or disabled.

23. A device according to claim 1 wherein the menu functions are managed using a touch screen when the device is on the surface, and a set of buttons when the device is pressurized or wet or in a dive mode.

24. A device according to claim 1 where an acceleration signal is obtained using a 3-axis accelerometer.

25. A device according to claim 1 where an acceleration signal is obtained using an analogue differentiator from the ambient pressure signal.

26. A device for controlling a diver's buoyancy comprising:
an inflatable bladder:
a plurality of electro-pneumatic valves coupled to the inflatable bladder for injecting gas into the inflatable bladder and venting gas from the inflatable bladder; and
an automatic buoyancy controller to manage the volume of gas in the bladder responsive to inherent to expansion and compression of gas disposed in the inflatable bladder resulting from a depth change, by operation of at least one of the plurality of electro-pneumatic valves as controlled from a calculation of a diver's depth and relative buoyancy derived directly from the diver's acceleration in a water column, without any direct measurement of gas flow or volume, where the electro-pneumatic valve is controlled using a series of conditions and conditional actions to add gas or remove gas, supported by a pulse width modulator to control the gas injection and venting process when moving to a desired depth under automatic control.

27. A device for venting gas from a diver's buoyancy compensation bladder, the device comprising:
a valve plug configured to open or to close a valve seat;
a spring configured to apply force to the valve plug to close the valve seat;
a piston configured to apply force to the valve plug to open the. Valve seat; and
a manual pull dump configured to open the valve seat manually;
wherein the spring is fully restrained for more than 50% of its length, and the movement of the valve plug is constrained by a centering mechanism that prevents the valve plug from moving laterally or angularly while the centering mechanism allowing movement with the face of the valve plug parallel to the valve seat along the axis of a line extending perpendicular to the valve seat under any combination of over-pressure or manual pulling action using the manual pull dump.
